(19) United States
(12) Patent Application Publication
(10) Pub. No.: US 2020/0023718 A1
(43) Pub. Date: Jan. 23, 2020

(54) WINDOW GLASS FOR VEHICLE AND WINDOW GLASS DEVICE FOR VEHICLE

(71) Applicant: AGC Inc., Tokyo (JP)

(72) Inventors: Toshifumi FUNATSU, Tokyo (JP); Fumiya SAWAMURA, Tokyo (JP)

(73) Assignee: AGC Inc., Tokyo (JP)

(21) Appl. No.: 16/515,933

(22) Filed: Jul. 18, 2019

(30) Foreign Application Priority Data
Jul. 23, 2018 (JP) 2018-137767
Jan. 9, 2019 (JP) 2019-001976

(51) Int. Cl. B60J 1/00; G02B 5/00; H01Q 1/12; H05B 3/84

(52) U.S. Cl. CPC B60J 1/002; G02B 5/003; B60J 1/02; H05B 3/84; B60J 1/001; H01Q 1/1285

(57) ABSTRACT

A window glass for vehicle includes a glass plate having a transmissive region transmitting visible light, and a light shielding film shielding visible light; a dielectric having a first surface and a second surface; a planar conductor arranged between the glass plate and the first surface of the dielectric; positive and negative electrodes connected to the planar conductor; one or more feeding electrodes and one or more grounding electrodes arranged on the second surface of the dielectric. The planar conductor generates heat by an electric voltage applied between the positive and negative electrodes. The feeding electrodes and the grounding electrodes are arranged to face the planar conductor via the dielectric so that the planar conductor receives at least electromagnetic waves of a VHF band. The positive electrode, the negative electrode, the feeding electrodes and the grounding electrodes are arranged to overlap with the light shielding film in a planar view.

### CROSS-REFERENCE TO RELATED APPLICATION

The present application is based on and claims priority under 35 U.S.C. § 119 of Japanese applications No. 2018-137767 filed Jul. 23, 2018, and No. 2019-001976 filed Jan. 9, 2019. The contents of the applications are incorporated herein by reference in their entirety.

### BACKGROUND OF THE INVENTION

### 1. Field of the Invention

The disclosure herein generally relates to a window glass for vehicle and a window glass device for vehicle.

### 2. Description of the Related Art

Window glasses for vehicles are required to be provided with multi-purpose antennas, such as an AM broadcasting, an FM broadcasting, a DAB (digital audio Broadcast), a remote entry control system without key, a digital television broadcasting, or a 4G communication, over a wide frequency range. Due to the limited area of the window glass for vehicle assigned for antennas, an antenna often has a complicated structure and a poor appearance.

Window glasses for vehicle (in particular, rear windows) provided with transparent or translucent conductive films that heat the window glasses, to prevent the window glasses from freezing or fogging have been known. Visibility and appearance of the window glasses with the conductive films are better than those of window glasses provided with a plurality of heater wires. Window glasses for vehicle having such conductive films and multi-purpose antennas have been known (See, for example, U.S. Pat. No. 9,837,699).

### SUMMARY OF THE INVENTION

### Technical Problem

In the window glass for vehicle described in U.S. Pat. No. 9,837,699, in which antenna elements are arranged near right and left edges of the window glass for vehicle, a part of the antenna elements remains in a field of vision of a driver. If the antennas are covered with black coating in order to enhance the appearance, the field of vision between the black coating near the right and left edges becomes narrower.

In view of the above-described problems, the disclosure of the present application aims at providing a window glass for vehicle having an antenna gain at least for a VHF (Very High Frequency) band, good appearance, a sufficient field of vision, and an antifogging effect; and a device including the window glass for vehicle.

### Solution to Problem

The present disclosure provides a window glass for vehicle and a window glass device for vehicle including a glass plate having a transmissive region that transmits visible light, and a light shielding film that shields visible light arranged around the transmissive region; a dielectric having a first surface that faces the glass plate, and a second surface opposite to the first surface; a planar conductor arranged between the glass plate and the first surface of the dielectric; a positive electrode connected to the planar conductor; a negative electrode connected to the planar conductor; one or more feeding electrodes arranged on the second surface of the dielectric; and one or more grounding electrodes arranged on the second surface of the dielectric. The planar conductor generates heat by an electric voltage applied between the positive electrode and the negative electrode. The feeding electrodes and the grounding electrodes are arranged to face the planar conductor via the dielectric so that the planar conductor receives at least electromagnetic waves of a VHF band. The positive electrode, the negative electrode, the feeding electrodes and the grounding electrodes are arranged to overlap with the light shielding film in a planar view.

### Effect of Invention

According to the disclosed technique, a window glass for vehicle having an antenna gain at least for a VHF band, good appearance, a sufficient field of vision, and an antifogging effect; and a device including the window glass for vehicle are provided.

### BRIEF DESCRIPTION OF THE DRAWINGS

Other objects, features and advantages of the present invention will become more apparent from the following detailed description when read in conjunction with the accompanying drawings, in which:

FIG. 1 is an exploded perspective view depicting an example of a configuration of a window glass for vehicle according to a first embodiment;

FIG. 2 is a plan view depicting an example of the configuration of the window glass (device) for vehicle according to the first embodiment;

FIG. 2A is a plan view depicting an example of the configuration of the window glass (device) for vehicle according to a first variation of the first embodiment;

FIG. 2B is a plan view depicting an example of the configuration of the window glass (device) for vehicle according to a second variation of the first embodiment;

FIG. 2C is an enlarged plan view depicting an example of the configuration of the window glass (device) for vehicle according to a third variation of the first embodiment;

FIG. 2D is an enlarged plan view depicting an example of the configuration of the window glass (device) for vehicle according to a fourth variation of the first embodiment;

FIG. 2E is an enlarged cross-sectional view depicting an example of the configuration of the window glass for vehicle according to the fourth variation of the first embodiment;

FIG. 2F is an enlarged plan view depicting an example of the configuration of the window glass for vehicle according to a fifth variation of the first embodiment;

FIG. 2G is an enlarged cross-sectional view depicting an example of the configuration of the window glass for vehicle according to the fifth variation of the first embodiment;

FIG. 2H is an enlarged plan view depicting an example of the configuration of the window glass for vehicle according to a sixth variation of the first embodiment;

FIG. 3 is an exploded perspective view depicting an example of a configuration of a window glass for vehicle according to a second embodiment;

FIG. 4 is a plan view depicting an example of the configuration of the window glass (device) for vehicle according to the second embodiment;

FIG. 4A is a plan view depicting an example of the configuration of the window glass (device) for vehicle according to a variation of the second embodiment;

FIG. 5 is a diagram depicting another example of the configuration of the feeding electrode according to the embodiment;

FIG. 6 is a cross-sectional view depicting a first example of the configuration of the window glass for vehicle according to the embodiment;

FIG. 7 is a cross-sectional view depicting a second example of the configuration of the window glass for vehicle according to the embodiment;

FIG. 8 is a cross-sectional view depicting a third example of the configuration of the window glass for vehicle according to the embodiment;

FIG. 9 is a cross-sectional view depicting a fourth example of the configuration of the window glass for vehicle according to the embodiment;

FIG. 10 is a cross-sectional view depicting a fifth example of the configuration of the window glass for vehicle according to the embodiment;

FIG. 11 is a cross-sectional view depicting a sixth example of the configuration of the window glass for vehicle according to the embodiment;

FIG. 12 is a diagram depicting an example of an equivalent circuit from a planar conductor to an amplifier;

FIG. 13 is a diagram depicting an example of a result of simulation for a relation between an input capacitance of an amplifier and a coupling capacitance when a coupling loss is 1 dB;

FIG. 14 is a diagram depicting an example of a result of simulation for a relation between an input capacitance of an amplifier and a coupling capacitance when the coupling loss is 0.5 dB; and

FIG. 15 is a diagram depicting an example of a relation between an area of a feeding electrode and an antenna gain.

### DETAILED DESCRIPTION OF THE PREFERRED EMBODIMENTS

In the following, with reference to drawings, embodiments according to the present disclosure will be described. Note that in each embodiment, a direction, such as parallel, right angle, orthogonal, horizontal, vertical, up-down, right-left, or the like, allows a deviation enough to keep the effect of the present invention. A shape of a corner is not limited to a right angle, and the corner may be rounded. The present invention is preferably applied to a rear glass arranged in a rear part of a vehicle. The application of the present invention is not limited to the rear glass, and the present invention may be applied to a windshield (front glass), a side glass, a roof glass, or the like.

In the following, a direction parallel to an X-axis (X-axis direction), a direction parallel to a Y-axis (Y-axis direction) and a direction parallel to a Z-axis (Z-axis direction) are assumed to be a right-left direction (horizontal direction) of a glass plate, an up-down direction (vertical direction) of the glass plate, and a direction orthogonal to a surface of the glass plate (normal direction), respectively. The X-axis direction is orthogonal to the Y-axis direction and the Z-axis direction, which are orthogonal to each other.

### First Embodiment

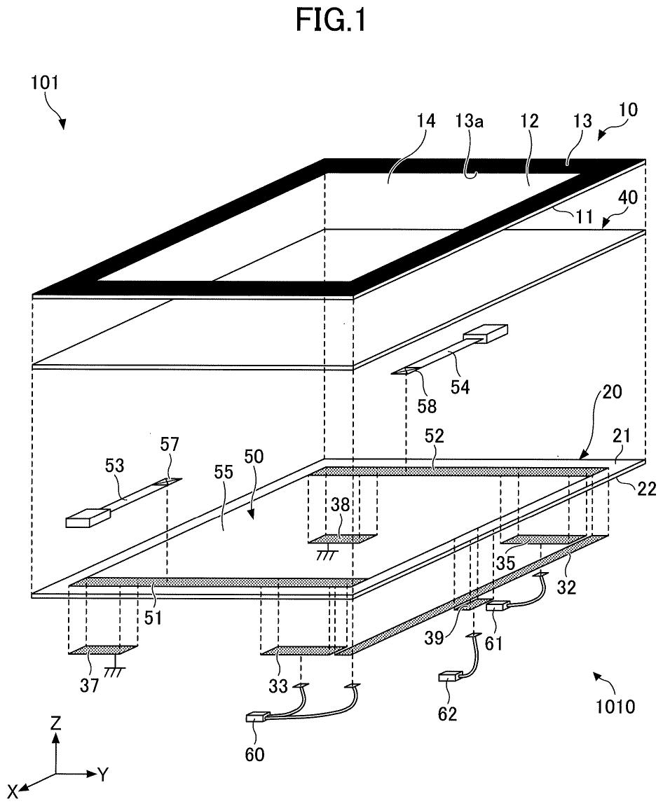

FIG. 1 is an exploded perspective view depicting an example of a configuration of a window glass for vehicle according to a first embodiment. In FIG. 1, the Z-axis directs from a vehicle interior side of the window glass to a vehicle exterior side of the window glass. The window glass 101 is a laminated glass in which a vehicle outside glass 10 and a vehicle inside glass 20 are laminated via an intermediate film 40. FIG. 1 illustrates members of the window glass 101 separated in the normal direction to the surface of the glass plate 10 or the glass plate 20.

The window glass 101 includes the glass plate 10 arranged on the vehicle outside, the glass plate 20 arranged on the vehicle inside, and a planar conductor 50 arranged inside the laminated glass.

The glass plates 10 and 20 are transparent dielectrics having flat plate shapes. At least one of the glass plates 10 and 20 may be translucent. The glass plate 10 is an example of a first glass plate, and the glass plate 20 is an example of a second glass plate.

The glass plate 10 has a plate surface 11 and a plate surface 12, which are opposite to each other. The plate surface 11 is a vehicle inside surface of the glass plate 10, and the plate surface 12 is a vehicle outside surface of the glass plate 10. The plate surface 12 is the vehicle outside surface of the laminated glass. The glass plate 10 has a transmissive region 14 that transmits visible light. On the plate surface 12, outside the transmissive region 14 a light shielding film 13 that shields visible light is arranged. The light shielding film will be described later.

The glass plate 20 has a plate surface 21 facing the plate surface 11 of the glass plate 10, and a plate surface 22 opposite to the plate surface 21. The plate surface 21 is a vehicle outside surface of the glass plate 20, and the plate surface 22 is a vehicle inside surface of the glass plate 20. The plate surface 22 is the vehicle inside surface of the laminated glass. The plate surface 21 is an example of a first surface, and the plate surface 22 is an example of a second surface.

The intermediate film 40 is a transparent or translucent dielectric arranged between the glass plate 10 and the glass plate 20. The glass plate 10 and the glass plate 20 are bonded to each other via the intermediate film 40. The intermediate film 40 is made of, for example, a thermoplastic polyvinylbutyral. A relative permittivity of the intermediate film 40 preferably falls within a range of 2.8 to 3.5.

FIG. 1 illustrates the planar conductor 50 arranged between the glass plate 10 and the glass plate 20. In the embodiment illustrated in FIG. 1, the planar conductor 50 is arranged between the plate surface 11 of the glass plate 10 and the plate surface 21 of the glass plate 20. The window glass 101 includes a positive electrode 57 connected to the planar conductor 50 and a negative electrode 58 connected to the planar conductor 50. The planar conductor 50 generates heat when an electric voltage is applied between the positive electrode 57 and the negative electrode 58. According to the heat from the planar conductor 50, the window glass 101 is prevented from freezing and fogging.

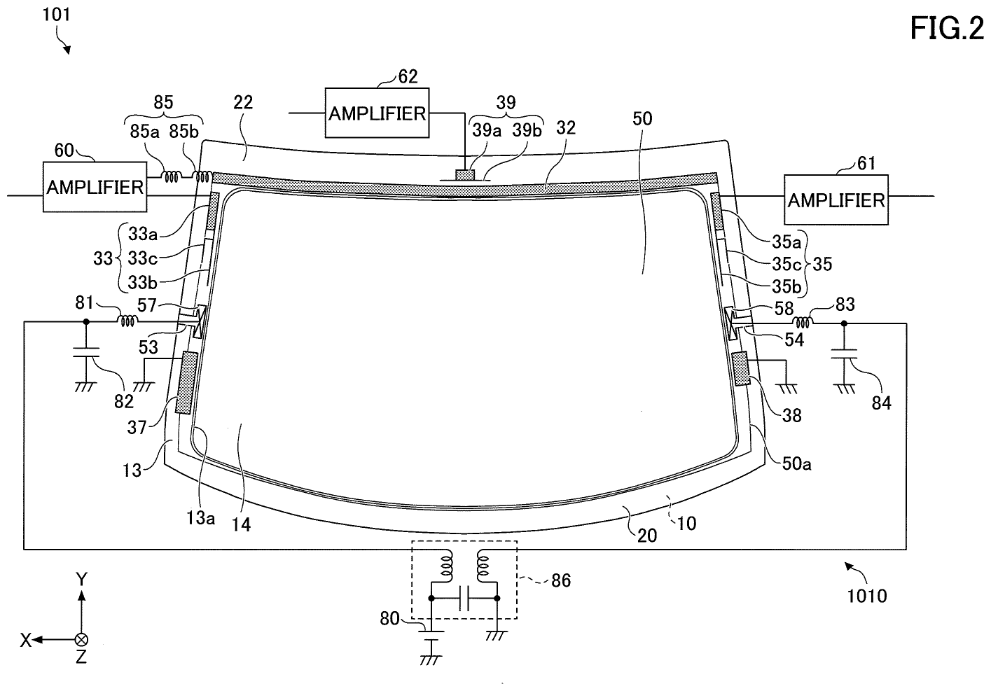

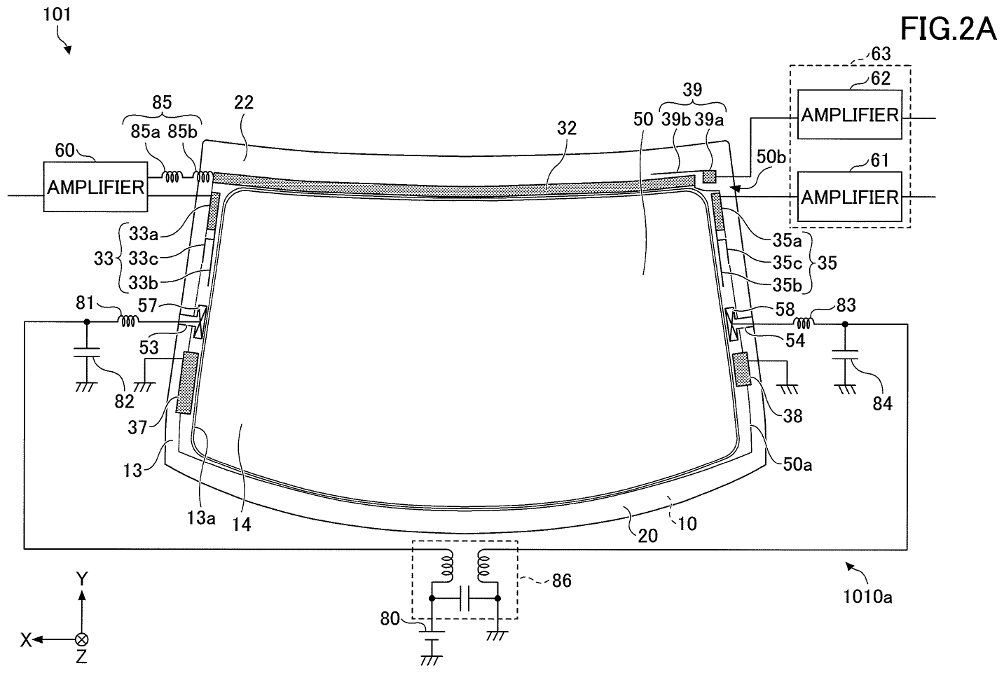

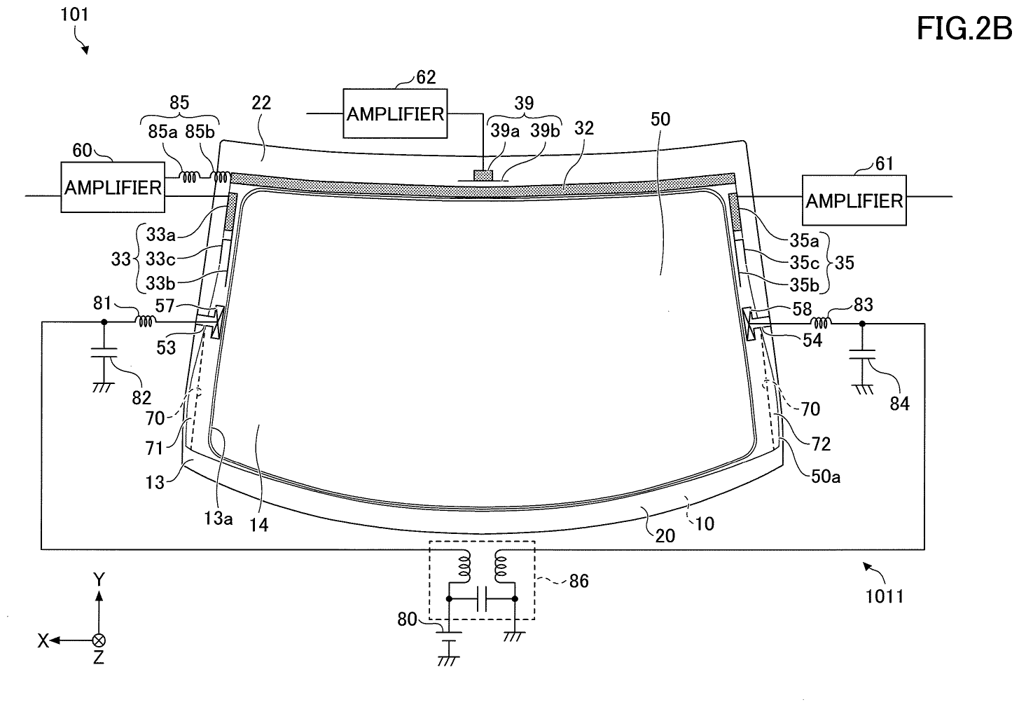

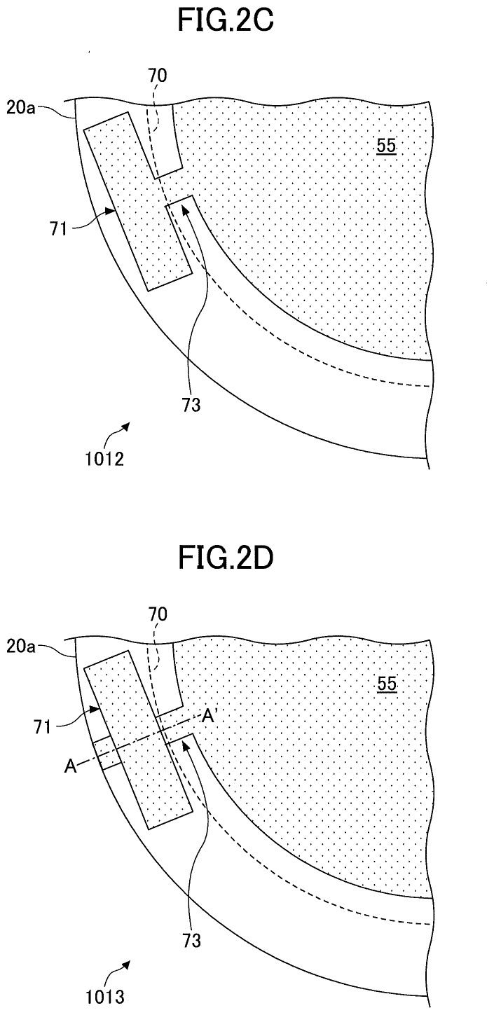

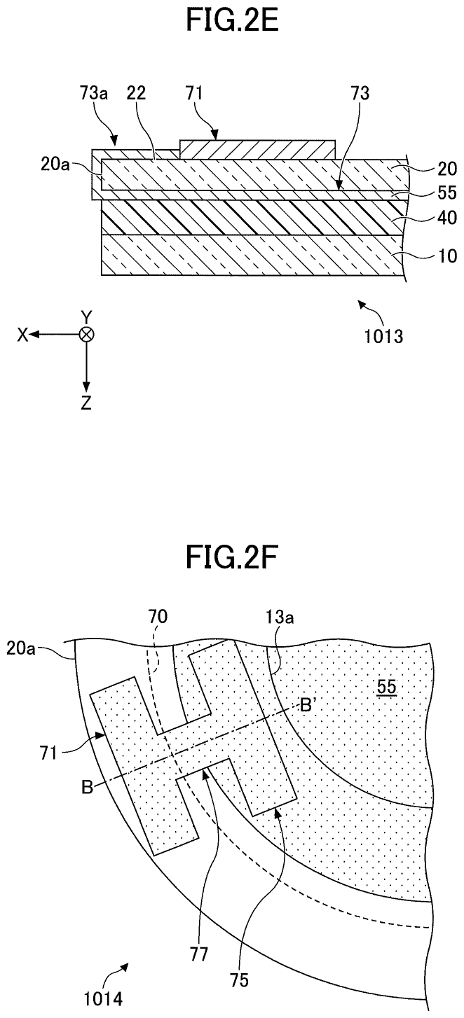

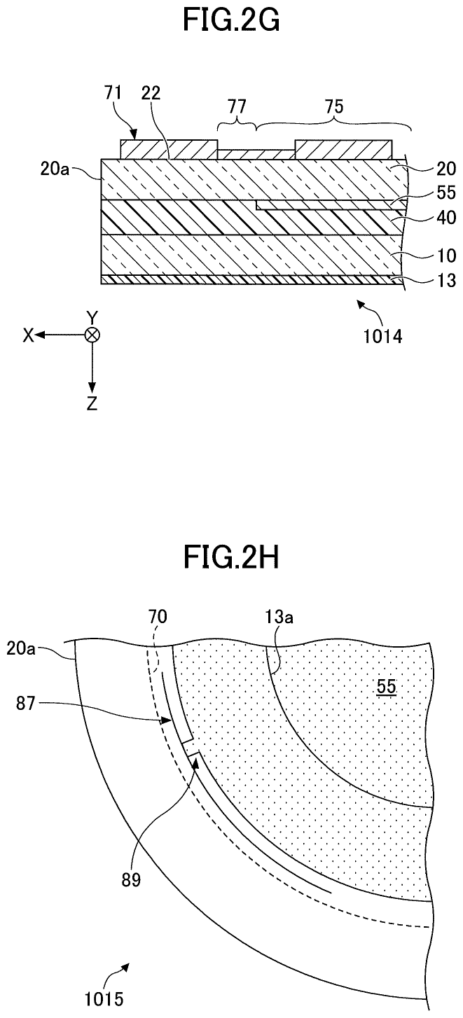

The positive electrode 57 is connected to a left edge of the planar conductor 50, and the negative electrode 58 is connected to a right edge of the planar conductor 50. The positive electrode 57 and the negative electrode 58 may be arranged between the plate surface 11 and the plate surface 21 (See FIG. 1). Alternatively, both the positive electrode 57 and the negative electrode 58 may be arranged on the plate surface 22 (See FIG. 2). When the positive electrode 57 is arranged on the left edge of the plate surface 22 viewed from the vehicle interior side of the window glass, an end of a flat electric cable 53 is connected to the left edge of the planar conductor 50 and the other end of the flat electric cable 53 is connected to the positive electrode 57. When the negative electrode 58 is arranged on the right edge of the plate surface 22 viewed from the vehicle interior side of the window glass, an end of a flat electric cable 54 is connected to the right edge of the planar conductor 50 and the other end of the flat electric cable 54 is connected to the negative electrode 58.

In the embodiment illustrated in FIG. 1, the planar conductor 50 forms an unseparated conductor surface. As illustrated in FIG. 1, the planar conductor 50 may have a conductive film 55 and a pair of bus bars 51 and 52 connected to the conductive film 55. The conductive film 55 is arranged between the intermediate film 40 and the glass plate 20, and made of a transparent or translucent conductor. The conductive film 55 includes a metal film such as an Ag film, a metal oxide film such as an ITO (indium tin oxide), a resin film containing conductive fine particles, a laminated body including various types of films, or the like. The conductive film 55 may be prepared by coating a conductive material on a resin film such as polyethylene terephthalate by a deposition method.

The conductive film 55 is arranged between the pair of bus bars 51 and 52, and heats the window glass 101. According to a direct current voltage applied between the bus bars 51 and 52, the conductive film 55 heats the window glass 101. Thus, ice and snow melting and defogging on the window glass 101 are performed. For example, the bas bar 51 arranged on the left edge of the planar conductor 50 viewed from the vehicle interior side of the window glass is connected to a positive electrode of a direct current power source via the flat electric cable 53. The bas bar 52 arranged on the right edge of the planar conductor 50 viewed from the vehicle interior side of the window glass is connected to a negative electrode of the direct current power source via the flat electric cable 54.

The window glass 101 further includes a feeding electrode 33 and a grounding electrode 37 arranged on the vehicle inside surface of the laminated glass. The feeding electrode 33 is an example of a first feeding electrode. The feeding electrode 33 is, for example, a conductor pattern on the plate surface 22. The grounding electrode 37 is an example of a first grounding electrode. The grounding electrode 37 is, for example, a conductor pattern on the plate surface 22. As illustrated in FIG. 1, the feeding electrode 33 and the grounding electrode 37 are arranged around the left edge of the plate surface 22, viewed from the vehicle interior side of the window glass, and have rectangular shapes. The feeding electrode 33 and the grounding electrode 37 may have other shapes, such as circular shapes, or polygonal shapes.

The feeding electrode 33 and the grounding electrode 37 face the planar conductor 50 via the glass plate 20 so that the planar conductor 50 receives at least electromagnetic waves of the VHF band. At least a part of the planar conductor 50 functions as a radiation conductor that receives electromagnetic waves of the VHF band. The feeding electrode 33 and the grounding electrode 37 facing the planar conductor 50 via the glass plate 20 form an inverted F antenna to which a power is fed via a capacitive coupling. The feeding electrode 33 and the grounding electrode 37 face the planar conductor 50 via the glass plate 20 so that the inverted F antenna receiving at least electromagnetic waves of the VHF band is formed. Thus, the window glass 101 has an antenna gain for the VHF band.

The VHF band is a band of frequency that falls within a range of 30 MHz to 300 MHz. Electromagnetic waves of the VHF band include, for example, FM broadcast waves, and electromagnetic waves of Band III of DAB. The feeding electrode 33 and the grounding electrode 37 may face the planar conductor 50 via the glass plate 20 so that the planar conductor 50 receives at least FM broadcast waves. Alternatively, the feeding electrode 33 and the grounding electrode 37 may face the planar conductor 50 via the glass plate 20 so that the planar conductor 50 receives at least electromagnetic waves of Band III of DAB.

An antenna gain for FM broadcast waves is preferably −15 dB or more, regardless of polarizations of electromagnetic waves, for obtaining sufficient reception sensitivity, and more preferably −12 dB or more. Moreover, an antenna gain for electromagnetic waves of Band III of DAB is preferably −10 dB or more, regardless of polarizations of electromagnetic waves, for obtaining sufficient reception sensitivity, and more preferably −7 dB or more.

The feeding electrode 33 may be foamed so as to receive at least electromagnetic waves of the UHF (Ultra High Frequency) band. The feeding electrode 33 functions as a radiation conductor that receives at least electromagnetic waves of the UHF band. With the feeding electrode 33, an antenna for the VHF band and for the UHF band is obtained.

The UHF band is a band of frequency that falls within a range of 300 MHz to 3 GHz. Electromagnetic waves of the UHF band include, for example, terrestrial digital television waves, and electromagnetic waves of L-Band of DAB. Thus, the feeding electrode 33 may be formed so as to receive at least terrestrial digital television waves. Alternatively, the feeding electrode 33 may be formed so as to receive at least electromagnetic waves of L-Band of DAB.

An antenna gain for terrestrial digital television (DTV) waves is preferably −10 dB or more, regardless of polarizations of electromagnetic waves, for obtaining sufficient reception sensitivity, and more preferably −7 dB or more.

At least a part of the feeding electrode 33, illustrated in FIG. 1, faces at least one of the bus bar 51 and the conductive film 55 via the glass plate 20. A first input unit of an amplifier 60 is connected to the feeding electrode 33. At least a part of the grounding electrode 37 faces at least one of the bus bar 51 and the conductive film 55 via the glass plate 20. The grounding electrode 37 is connected to the ground level. Thus, a signal output from the planar conductor 50 that receives electromagnetic waves is input to the first input unit of the amplifier 60 via a capacitive coupling between the planar conductor 50 and the feeding electrode 33. A signal output from the feeding electrode 33 that receives electromagnetic waves is also input to the first input unit of the amplifier 60. The signal input to the first input unit is output from the amplifier 60 passing through a band pass filter.

The window glass 101 may be provided with a feeding electrode 35 and a grounding electrode 38 arranged on the vehicle inside surface of the laminated glass. The feeding electrode 35 is an example of the first feeding electrode. The feeding electrode 35 is, for example, a conductor pattern on the plate surface 22. The grounding electrode 38 is an example of a first grounding electrode. The grounding electrode 38 is, for example, a conductor pattern on the plate surface 22. As illustrated in FIG. 1, the feeding electrode 35 and the grounding electrode 38 are arranged around the right edge of the plate surface 22, viewed from the vehicle interior side of the window glass, and have rectangular shapes. The feeding electrode 35 and the grounding electrode 38 may have other shapes, such as circular shapes, or polygonal shapes.

With the feeding electrode 35 having the same structure as the feeding electrode 33 and the grounding electrode 38 having the same structure as the grounding electrode 37, a diversity antenna is formed. Description of the structure of the feeding electrode 35 and the grounding electrode 38 will be omitted, because the descriptions of the structure of the feeding electrode 33 and the grounding electrode 37 can be applied.

At least a part of the feeding electrode 35, illustrated in FIG. 1, faces at least one of the bus bar 52 and the conductive film 55 via the glass plate 20. An input unit of an amplifier 61 is connected to the feeding electrode 35. At least a part of the grounding electrode 38 faces at least one of the bus bar 52 and the conductive film 55 via the glass plate 20. The grounding electrode 38 is connected to the ground level. Thus, a signal output from the planar conductor 50 that receives electromagnetic waves is input to the input unit of the amplifier 61 via a capacitive coupling between the planar conductor 50 and the feeding electrode 35. A signal output from the feeding electrode 35 that receives electromagnetic waves is also input to the input unit of the amplifier 61.

The window glass 101 may be provided with a feeding electrode 32 arranged on the vehicle inside surface of the laminated glass. The feeding electrode 32 is an example of a second feeding electrode. The feeding electrode 32 is, for example, a conductor pattern on the plate surface 22. As illustrated in FIG. 1, the feeding electrode 32 is arranged around the upper edge of the plate surface 22, viewed from the vehicle interior side of the window glass, and has a rectangular shape. The shape is not limited to this, and the feeding electrode 32 may have a circular shape, a polygonal shape, or the like.

The feeding electrode 32 faces the planar conductor 50 via the glass plate 20, so that the planar conductor 50 receives at least electromagnetic waves of the MF (Medium Frequency) band. That is, at least a part of the planar conductor 50 functions as a radiation conductor that receives electromagnetic waves of the MF band.

Alternatively, the feeding electrode 32 may face the planar conductor 50 via the glass plate 20 so that the planar conductor 50 receives at least electromagnetic waves of the MF band and electromagnetic waves of the HF (High Frequency) band. That is, at least a part of the planar conductor 50 functions as a radiation conductor that receives electromagnetic waves of the MF band and electromagnetic waves of the HF band.

With the feeding electrode 32 having the above-described structure, an antenna that receives also electromagnetic waves of the MF band (or, electromagnetic waves of the MF band and electromagnetic waves of the HF band) is famed. The MF band is a band of frequency that falls within a range of 300 kHz to 3 MHz. Electromagnetic waves of the MF band include, for example, AM broadcast waves. The HF band is a band of frequency that falls within a range of 3 MHz to 30 MHz. The HF band is also referred to as a SW (Short Wave) band. The feeding electrode 32 and the planar conductor 50 may be configured so as to receive at least AM broadcast waves. An electric voltage of AM broadcast waves is preferably 15 dBpV or more for obtaining sufficient reception sensitivity, and more preferably 18 dBpV or more.

At least a part of the feeding electrode 32, illustrated in FIG. 1, faces at least a part of the upper edge of the conductive film 55 via the glass plate 20. A second input unit of the amplifier 60 is connected to the feeding electrode 32. Thus, a signal output from the planar conductor 50 that receives electromagnetic waves is input to the second input unit of the amplifier 60 via a capacitive coupling between the planar conductor 50 and the feeding electrode 32.

The window glass 101 may be provided with a feeding electrode 39 arranged on the vehicle inside surface of the laminated glass. The feeding electrode 39 is, for example, a conductor pattern on the plate surface 22, and located outside the feeding electrode 32. As illustrated in FIG. 1, the feeding electrode 39 is arranged around the upper edge of the plate surface 22, viewed from the vehicle interior side of the window glass, and has a rectangular shape. The shape is not limited to this, and the feeding electrode 39 may have a circular shape, a polygonal shape, or the like.

The feeding electrode 39 may be foamed so as to receive at least electromagnetic waves of the UHF band. That is, the feeding electrode 39 may be formed so that the feeding electrode 39 itself functions as a radiation conductor that receives electromagnetic waves of the UHF band. Thus, a UHF antenna that receives three channels of signals by using the feeding electrodes 33, 35 and 39 is famed.

A part of the feeding electrode 39 illustrated in FIG. 1 may face the conductive film 55 via the glass plate 20, or may not face the conductive film 55. A signal output from the feeding electrode 39 that receives electromagnetic waves is input to the input unit of the amplifier 62.

The glass plate 10 is provided with a light shielding film 13 that shields visible light. The light shielding film 13 is arranged along the outer circumferential edge of the glass plate 10. The light shielding film 13 overlaps with the pair of bus bars 51 and 52; the positive electrode 57; the negative electrode 58; the feeding electrodes 32, 33, 35, and 39; and the grounding electrodes 37 and 38, in the thickness direction of the glass plate 10. The light shielding film 13 specifically includes a ceramic film, such as a black ceramic film. Parts of the pair of bus bars 51 and 52; the positive electrode 57; the negative electrode 58; the feeding electrodes 32, 33, 35 and 39; and the grounding electrodes 37 and 38 that overlap with the light shielding film 13, in the planar view of the glass plate 10, are not recognized when the window glass 101 is viewed from the vehicle exterior side of the window glass 101. Thus, design properties of the window glass 101 and the vehicle are enhanced.

As described above, in the planar view of the window glass 101, the pair of bus bars 51 and 52; the positive electrode 57; the negative electrode 58; the feeding electrodes 32, 33, 35 and 39; and the grounding electrodes 37 and 38 overlap with the light shielding film 13. Thus, the appearance of the window glass is enhanced and a sufficient field of vision of the window glass is obtained.

At least one of the feeding electrodes 32, 33, 35 and 39; and the grounding electrodes 37 and 39 may be formed by printing a material containing conductive metal, such as a silver paste, on the plate surface 22 of the glass plate 20 and baking it, or may be formed with a metallic plate (metallic foil).

An area of the feeding electrode 33 or the feeding electrode 35 (in the following, also referred to as an “area A_{F}”) preferably falls within a range of 420 mm² to 8000 mm², for increasing the antenna gain for the VHF band. When the area A_{F} is less than 420 mm², the antenna gain is reduced to a value that is lower than the maximum value by 6 dB. When the area A_{F} exceeds 8000 mm², i.e. the size of the feeding electrode 33 (or the feeding electrode 35) increases, a part of the feeding electrode 33 (or a part of the feeding electrode 35) may enter the transmissive region 14, and the appearance may be degraded or the field of vision may be reduced.

In order to enhance the antenna gain for the VHF band, the area A_{F} is preferably 500 mm² or more, and more preferably 1000 mm² or more. Moreover, in order to enhance the appearance and to increase the field of vision, the area A_{F} is preferably 2500 mm² or less, and more preferably 2000 mm² or less.

FIG. 2 is a plan view depicting an example of a configuration of the window glass (device) for vehicle according to the first embodiment. FIG. 2 illustrates the window glass (device) for vehicle installed in a vehicle viewed from the vehicle interior side of the window glass. In the state where the window glass (device) for vehicle in FIG. 2 is installed in the vehicle, the Y-axis directs in the direction separating from the surface of the ground. The feeding electrode 33 includes a rectangular element 33a, a linear element 33b, and a bent element 33c. The feeding electrode 33 extends in the Y-axis direction. The linear element 33b is an example of a first element, and the bent element 33c is an example of a second element.

The rectangular element 33a has an oblong shape and thus has a pair of long sides and a pair of short sides. The linear element 33b extends from a lower side of the rectangular element 33a. A width of the linear element 33b is narrower than the width of the lower side of the rectangular element 33a, which is one of the short sides of the rectangular element 33a. According to the length of the linear element 33b, the antenna gain of the VHF band (in particular, the frequency band of Band III of DAB) is enhanced. The bent element 33c is conductively connected to the rectangular element 33a, and is of a width that is narrower than the width of the short side of the rectangular element 33a. The bent element 33c extends from a part of the linear element 33b other than the ends, extending in a direction orthogonal to the direction in which the linear element 33b extends, then bends, and extends downward. The bend element 33c has an open end. According to the length of the bent element 33c, the antenna gain of the UHF band, including the terrestrial digital television broadcast, the L-Band of DAB, and the like, is enhanced.

The bent element 33c may be absent in the feeding electrode 33. The linear element 33b and the bent element 33c may be absent in the feeding electrode 33.

The feeding electrode 35 has a rectangular element 35a, a linear element 35b and a bent element 35c. The feeding electrode 35 extends in the Y-axis direction. The linear element 35b is an example of the first element. The bent element 35c is an example of the second element. The feeding electrode 35 has the same structure as the feeding electrode 33, and an explanation of the feeding electrode 35 will be omitted.

The feeding electrode 33 and the grounding electrode 37 are arranged on the left of the left side of the transmissive region 14, viewed from the vehicle interior side of the window glass 101 installed in the vehicle. The feeding electrode 35 and the grounding electrode 38 are arranged on the right of the right side of the transmissive region 14, viewed from the vehicle interior side of the window glass 101 installed in the vehicle. The above-described electrodes overlap with the light shielding film 13 in the planar view, and the appearance is enhanced. The left side of the transmissive region 14 viewed from the vehicle interior side of the window glass 101 installed in the vehicle is an example of a first side. The right side of the transmissive region 14, viewed from the vehicle interior side of the window glass 101 installed in the vehicle is an example of a second side.

The feeding electrode 32 is arranged above the upper side of the transmissive region 14, viewed from the vehicle interior side of the window glass 101 installed in the vehicle. The feeding electrode 32 extends in the horizontal direction. In the embodiment, the feeding electrode 32 is arranged from a left edge of the glass plate 20 to a right edge of the glass plate 20 along an upper edge of the glass plate 20. The feeding electrode 32 extends in the X-axis direction. The feeding electrode 32 “arranged along the upper edge of the glass plate 20” may contact the upper edge of the glass plate 20, or may be separated from the upper edge.

The feeding electrode 39 includes a rectangular element 39a and a linear element 39b. The feeding electrode 39 extends in the X-axis direction. The linear element 39b extends from the right side of the rectangular element 39a to the right in the X-axis direction and extends from the left side of the rectangular element 39a to the left in the X-axis direction. The linear element 39b may be absent.

An inner edge 13a of the light shielding film 13 is located within an outer edge 50a of the planar conductor 50. The outer edge 50a overlaps with the light shielding film 13 in the planar view. Thus, the outer edge 50a of the planar conductor 50 is shielded by the light shielding film 13, and the appearance is enhanced.

A window glass device 1010 includes the window glass 101; a positive electrode side coil 81 connected to the positive electrode 57; and a negative electrode side coil 83 connected to the negative electrode 58. The coils 81 and 83 block at least signals of the VHF band. Thus, high frequency components of the signal of the VHF band are prevented from entering the direct current power source 80 and the ground level. The coils 81 and 83 preferably block at least signals of the frequency band of FM broadcast waves from among signals of the VHF band, and more preferably block both signals of the frequency band of FM broadcast waves and signals of the frequency band of the Band III of DAB.

An end of the positive electrode side coil 81, opposite to the positive electrode 57, may be connected to the ground level via a capacitor 82. An end of the negative electrode side coil 83, opposite to the negative electrode 58, may be connected to the ground level via a capacitor 84. According to capacitances of the capacitors 82 and 84, an impedance of the circuit is adjusted.

The window glass device 1010 further includes a choke coil 86 connected to the positive electrode 57 and the negative electrode 58. The choke coil 86 blocks at least signals of the MF band. The choke coil 86 has a structure of a transformer including a primary coil and a secondary coil. The positive electrode 57 is connected to the positive electrode of the direct current power source 80 via the primary coil, and the negative electrode 58 is connected to the negative electrode of the direct current power source 80 via the secondary coil. According to the choke coil 86, the signals of the MF band, such as AM broadcast waves, received by the planar conductor 50, are prevented from entering the direct current power source 80 and the ground level.

The window glass device 1010 may be provided with a coil 85 connected to the feeding electrode 32. The coil 85 is preferably an inductor with a configuration in which a coil 85a that blocks at least the signals of the VHF band and a coil 85b that blocks at least the signals of the UHF band are connected in series.

### First Variation of the First Embodiment

FIG. 2A is a plan view depicting an example of a configuration of a window glass device for vehicle according to a first variation of the first embodiment. The window glass device for vehicle 1010a illustrated in FIG. 2A, includes a notch part 50b, in which a conductive film is absent, at an upper right corner portion of the conductive film 55, for example. The window glass device for vehicle 1010a further includes a feeding electrode 39 that overlaps with at least a part of the notch part 50b in the planar view. An outer edge 50a of the planar conductor 50, which is surrounded by four sides and has a quadrangular shape, is locally bent toward the inside of the planar conductor 50. The notch part 50b is famed by the bending portion.

The notch part 50b, illustrated in FIG. 2A, includes, for example, a rectangular element 39a, and a linear element 39b extending in the X-axis direction from the rectangular element 39a. The feeding electrode 39, arranged in at least a part of the notch part 50b, located in the upper right portion of the glass plate 20, weakens the capacitive coupling between the feeding electrode 39 and the conductive film 55. Moreover, an amplifier 61 connected to the feeding electrode 35 is arranged near an amplifier 62 connected to the feeding electrode 39. Furthermore, the amplifier 61 and the amplifier 62 are integrated in a casing 63. Thus, the arrangement of circuit is prevented from becoming complicated. The arrangement of the notch part 50b is not limited to the upper right portion of the conductive film 55. The notch part 50b may be the upper left portion of the conductive film 55, or may be located as appropriate.

### Second Variation of the First Embodiment

FIG. 2B is a plan view depicting an example of a configuration of a window glass device for vehicle according to a second variation of the first embodiment. The window glass device for vehicle 1011, illustrated in FIG. 2B, includes a conductive film 55 interposed between a glass plate 10 arranged on the vehicle outside and a glass plate 20 arranged on the vehicle inside; and parts thereof that face the metal body of the vehicle (flanges) on the right and the left of the conductive film 55, in the planar view. Dashed lines in FIG. 2B indicate boundaries (edge portions) of the vehicle metallic body. The conductive film 55 has right and left regions that face the parts of the vehicle made of metal, i.e. a first side region 71 and a second side region 72. In the window glass device for vehicle 1011, the first side region 71 or the second side region 72 may be absent. The same applies to the following variations. At least one of or both the first side region 71 and the second side region 72 will also be referred to simply as a “side region”.

In the second variation of the first embodiment, in the planar view, the metallic body region illustrated in FIG. 2B facing the first side region 71 corresponds to the grounding electrode 37, and the metallic body region illustrated in FIG. 2B facing the second side region 72 corresponds to the grounding electrode 38. Thus, the grounding electrodes in the window glass device 1011 according to the embodiment may be the metallic body of the vehicle. With the metallic body being separated from the first side region 71 and the second side region 72, the space between the metallic body and the first side region 71 or the second side region 72 may be air, or may be fixed at least in part via a material having a predetermined dielectric constant, such as a resin, for example, an adhesive agent such as urethane resin. Furthermore, both resin and air may be present between the first side region 71 or the second side region and the metallic body. The first side region 71 and the second side region 72 are connected to the ground level via capacitive coupling.

When the metallic body is used for the grounding electrodes 37 and 38, as described in the second variation of the first embodiment, a coupling capacitance between the first side region 71 and the metallic body and a coupling capacitance between the second side region 72 and the metallic body in the conductive film 55 (in the following, referred to as a “coupling capacitance C_{B}”) are preferably 3 pF or more. With the coupling capacitance C_{B}of 3 pF or more, the connection between the conductive film 55 and the metallic body corresponding to the ground level becomes stable for signals with predetermined frequency. The coupling capacitance C_{B} is preferably 4 pF or more, and more preferably 5 pF or more. Moreover, according to the upper limit of the area where the metallic bodies overlap with the side regions, the coupling capacitance C_{B} is preferably 130 pF or less.

Moreover, each of the areas of the first side region 71 and the second side region 72 is preferably 700 mm² or more, and more preferably 800 mm² or more, which is sufficient for the stable connection between the first side region 71 or the second side region 72 and the metallic body corresponding to the ground level. Moreover, each of the areas of the first side region 71 and the second side region 72 is preferably 20000 mm² or less so as to secure areas of the regions outside the boundaries of the metallic body. The grounding electrodes in the window glass device for vehicle 1011, illustrated in FIG. 2B, are metallic bodies. The embodiment is not limited to this, and the grounding electrodes 37 and 38 in the window glass device for vehicle 1010 as illustrated in FIG. 2, may be used in addition to the metallic bodies.

### Third Variation of the First Embodiment

FIG. 2C is an enlarged plan view depicting an example of the configuration of the window glass device for vehicle according to a third variation of the first embodiment. FIG. 2C is an enlarged view of a part of the window glass device for vehicle including the first side region 71. Explanations of the same configuration and the same effect as those in the second variation of the first embodiment will be omitted in the following. The window glass device for vehicle 1012, illustrated in FIG. 2C, includes the conductive film 55 interposed between the glass plate 10 arranged on the vehicle outside and the glass plate 20 arranged on the vehicle inside; and the first side region 71 that faces the metallic body. In the window glass device for vehicle 1012 according to the third variation of the first embodiment, the conductive film 55 has the first side region 71 arranged as an island, connected via a first connection part 73 that crosses the boundary of the metallic body (dashed line 70) in the planar view. When the width of the first connection part 73 crossing the boundary of the metallic body is smaller than the maximum value of the width of a metallic body side part of the first side region 71, in the planar view, the first side region 71 is defined to be arranged as an island. In the window glass device for vehicle 1012 according to the third variation of the first embodiment, the first side region 71 is located between an edge 20a of the glass plate 20 and the dashed line 70, in the planar view. According to the third variation of the first embodiment, the area of the first side region 71 that functions as a grounding electrode is controlled, and a stable connection to the metallic body corresponding to the ground level is obtained with the connection capacitance C_{B} of 3 pF or more. Furthermore, installation of the window glass device for vehicle according to the third variation of the first embodiment in a vehicle does not require wire connections, and processes of the installation are reduced.

The second side region 72 according to the third variation of the first embodiment, which is not shown in FIG. 2C, has the same configuration as the configuration of the first side region 71. The conductive film 55 may have the second side region 72 (not shown) arranged as an island, connected via a second connection part (not shown) that crosses the boundary of the metallic body in the planar view. At least one of or both the first connection part 73 and the second connection part are also simply referred to as “connection parts”.

### Fourth Variation of the First Embodiment

FIG. 2D is an enlarged plan view depicting an example of the configuration of the window glass device for vehicle according to a fourth variation of the first embodiment. FIG. 2D is an enlarged view of a part of the window glass device for vehicle including the first side region 71. Explanations of the same configuration and the same effect as those in the second variation of the first embodiment will be omitted. The window glass device for vehicle 1013, illustrated in FIG. 2D, includes the conductive film 55 interposed between the glass plate 10 arranged on the vehicle outside and the glass plate 20 arranged on the vehicle inside; and the first side region 71 that faces the metallic body.

FIG. 2E is a cross-sectional view depicting an example of a lamination structure of the window glass device for vehicle according to the fourth variation of the first embodiment, obtained by cutting along a chain line A-A′ in FIG. 2D. The window glass device for vehicle 1013 has an intermediate film 40 and the conductive film 55 between the glass plate 10 and the glass plate 20. The present invention is not limited to the above-described configuration. For example, in the window glass device for vehicle 1013, two intermediate films may be interposed between the glass plate 10 and the glass plate 20, and the conductive film 55 may be arranged between the two intermediate films.

In the window glass device for vehicle 1013 according to the fourth variation of the first embodiment, the conductive film 55 has the first side region 71 arranged as an island, connected via a first connection part 73 that crosses the boundary of the metallic body (dashed line 70) in the planar view to the conductive film 55. The first side region 71 is arranged on a main surface (plate surface 22) of the glass plate 20 that faces a metallic body. The first connection part 73 extends to a side surface of the glass plate 20 (edge surface 20a), and further extends along the side surface 20a to the main surface of the glass plate 20 (plate surface 22) that faces the metallic body. The first connection part 73 may have a first turnaround part 73a that turns back along the main surface (plate surface 22) of the glass plate 20 facing the metallic body.

The conductive film 55 according to the fourth variation of the first embodiment may be formed with a metallic film deposited on a resin film including the first connection part 73 and the first side region 71. However, the present invention is not limited to the above-described mode, if the conductive film 55 has a predetermined conductivity. For example, the first side region 71 may be made of a conductive material different from that of other parts of the conductive film 55. Moreover, the first connection part 73 and the first side region 71 may be made of a conductive material different from that of other parts of the conductive film 55. For a material between the first side region 71 and the metallic body, the material described in the second variation of the first embodiment (including air) may be used. The material is connected to the ground level via a capacitive coupling. According to the above-described configuration, the area of the first side region 71 that functions as a grounding electrode is changeable, and a stable connection to the metallic body corresponding to the ground level is obtained so that the coupling capacitance C_{B} is 3 pF or more.

The second side region 72 according to the fourth variation of the first embodiment may have the same configuration as the first side region 71 (not shown in FIGS. 2D and 2E). The conductive film 55 according to the fourth variation of the first embodiment may have the second side region 72 arranged as an island, arranged on the main surface of the glass plate 20 facing the metallic body, and connected to the conductive film 55 via a second connection part. The second connection part crosses the boundary of the metallic body in the planar view, and has a second turnaround part (not shown). At least one of or both the first turnaround part 73a and the second turnaround part are also referred to simply as “turnaround parts”.

### Fifth Variation of the First Embodiment

FIG. 2F is an enlarged plan view depicting an example of the configuration of the window glass device for vehicle according to a fifth variation of the first embodiment. FIG. 2F is an enlarged view of a part of the window glass device for vehicle including the first side region 71. Explanations of the same configuration and the same effect as those in the second variation of the first embodiment will be omitted in the following. The window glass device for vehicle 1014, illustrated in FIG. 2F, includes the conductive film 55 interposed between the glass plate 10 arranged on the vehicle outside and the glass plate 20 arranged on the vehicle inside; and the first side region 71 that faces the metallic body.

The first side region 71 is conductively connected to a first capacitive coupling part 75 via a first connection part 77. The first side region 71, the first connection part 77 and the first capacitive coupling part 75 are arranged on the vehicle inside surface of the glass plate 20 that is arranged on the vehicle interior side of the window glass device for vehicle. In the window glass device for vehicle according to the fifth variation of the first embodiment, an edge of the light shielding film 13 (inner periphery 13a) is located within the first capacitive coupling part 75. Then, the light shielding film 13 overlaps with the first capacitive coupling part 75, and at least a part of the first connection part 77 overlaps with the light shielding film 13. Thus, the first capacitive coupling part 75 and the first connection part 77 are not viewed.

FIG. 2G is a cross-sectional view depicting an example of a lamination structure of the window glass device for vehicle according to the fifth variation of the first embodiment, obtained by cutting along a chain line B-B′ in FIG. 2F. The window glass device for vehicle 1014 has an intermediate film 40 and the conductive film 55 between the glass plate 10 and the glass plate 20. The present invention is not limited to the above-described configuration. For example, in the window glass device for vehicle 1014, two intermediate films may be interposed between the glass plate 10 and the glass plate 20, and the conductive film 55 may be arranged between the two intermediate films.

In the window glass device for vehicle 1014 according to the fifth variation of the first embodiment, the conductive film 55 is provided with the first side region 71 arranged as an island, connected via a first connection part 77 to the conductive film 55. In the window glass device for vehicle 1014 according to the fifth variation of the first embodiment, the first capacitive coupling part 75 overlaps with the conductive film 55 in the planar view, and thereby the first capacitive coupling part 75 is electrically connected to the conductive film 55 for signals with a predetermined frequency. The conductive film 55 is connected to the metallic body conductively with a coupling capacitance C₁. The coupling capacitance C₂ is a combined capacitance of a coupling capacitance C₁ between the conductive film 55 and the first capacitive coupling part 75; and the coupling capacitance C_{B} between the first side region 71 and the metallic body, i.e. C₂=C₁·C_{B}/(C₁+C_{B}). The coupling capacitance C₂ is preferably 3 pF or more.

In the fifth variation of the first embodiment, an area in which the conductive film 55 overlaps with the first capacitive coupling part 75, and an area in which the first side region 71 overlaps with the metallic body are preferably determined so that the combined capacitance C₂ is 3 pF or more. When the combined capacitance C₂ is 3 pF or more, a stable connection between the conductive film 55 and the metallic body corresponding to the ground level is obtained. The combined coupling capacitance C₂ is preferably 4 pF or more, and more preferably 5 pF or more. Although not particularly limited, the combined coupling capacitance C₂ is preferably 130 pF or less, from the relationship of upper limits of the area in which the conductive film 55 overlaps with the first capacitive coupling part 75, and the area in which the first side region 71 overlaps with the metallic body.

The second side region 72 according to the fifth variation of the first embodiment may have the same configuration as the first side region 71 (not shown in FIGS. 2F and 2G). The second side region 72, the second connection part (not shown) and the second capacitive coupling part (not shown) are arranged on the vehicle inside surface of the glass plate 20. At least one of or both the first connection part 77 and the second connection part are also referred to simply as “connection parts”. At least one of or both the first capacitive coupling part 75 and the second capacitive coupling part are also referred to simply as “capacitive coupling parts”.

### Sixth Variation of the First Embodiment

FIG. 2H is an enlarged plan view depicting an example of the configuration of the window glass device for vehicle according to a sixth variation of the first embodiment. FIG. 2H is an enlarged view of a part of the window glass device for vehicle including a first linear conductor 87. Explanations of the same configuration and the same effect as those in the second variation of the first embodiment will be omitted in the following. The window glass device for vehicle 1015, illustrated in FIG. 2H, includes the conductive film 55 interposed between the glass plate 10 arranged on the vehicle outside and the glass plate 20 arranged on the vehicle inside; and the first linear conductor 87 that is conductively connected to the conductive film 55 via a first connection part 89 included in the conductive film 55.

The first linear conductor 87, illustrated in FIG. 2H, does not overlap with the metallic body in the planar view. The first linear conductor 87 is arranged alongside the metallic body, for example, along an edge surface (dashed line 70) of the metallic body separated from the edge surface by a predetermined distance. A length, a width and an arrangement position of the first linear conductor 87 are determined so that the metallic body and the first linear conductor 87 are capacitively coupled with each other in an oblique direction in the planar view. Specifically, the length, the width and the arrangement position are determined so that the coupling capacitance C₃ between the first linear conductor 87 and the metallic body is 3 pF or more. The closest distance between the first linear conductor 87 and the metallic body is required to be 5 mm or less. The maximum distance between the first linear conductor 87 and the metallic body is preferably 5 mm or less. The first linear conductor 87 may be made of the same material as the conductive film 55. The material of the first linear conductor 87 may contain silver, copper, aluminum or the like. The coupling capacitance C₃ is preferably 4 pF or more, and more preferably 5 pF or more. The coupling capacitance C₃ is preferably 130 pF or less so that the first linear conductor 87 is not unnecessarily long.

In the sixth variation of the first embodiment, a second linear conductor (not shown) arranged in a right part of the window glass may have the same configuration as the first linear conductor 87. The conductive film 55 according to the sixth variation of the first embodiment may have a second connection part (not shown), and the second linear conductor may be conductively connected to the conductive film 55 via the second connection part. At least one of or both the first connection part 89 and the second connection part are also referred to simply as “connection parts”. At least one of or both the first linear conductor 87 and the second linear conductor are also referred to simply as “linear conductors”.

### Second Embodiment

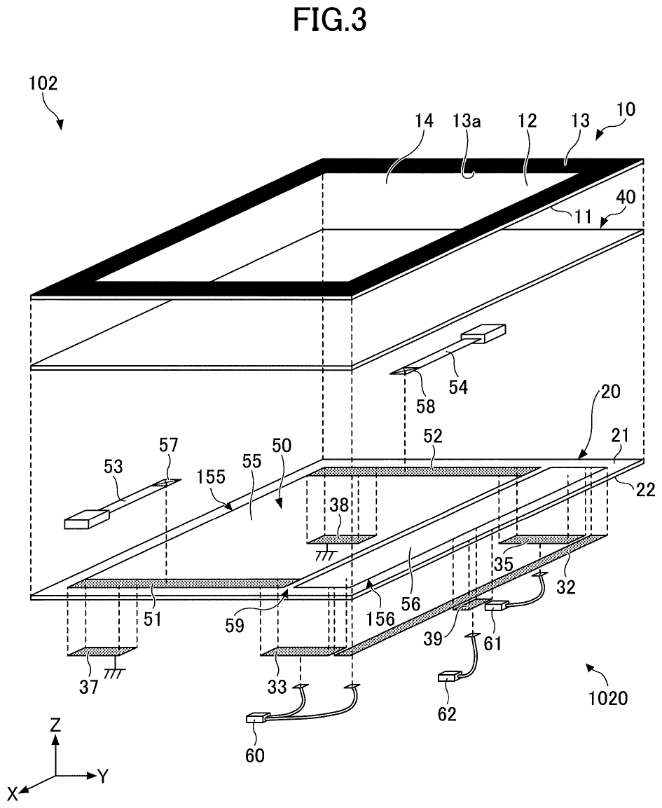

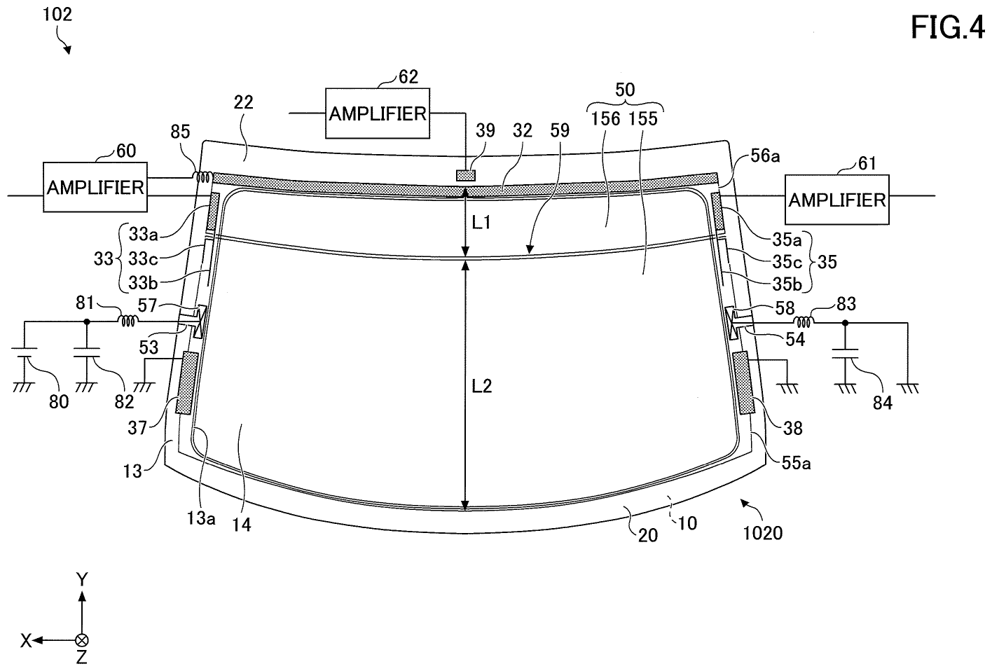

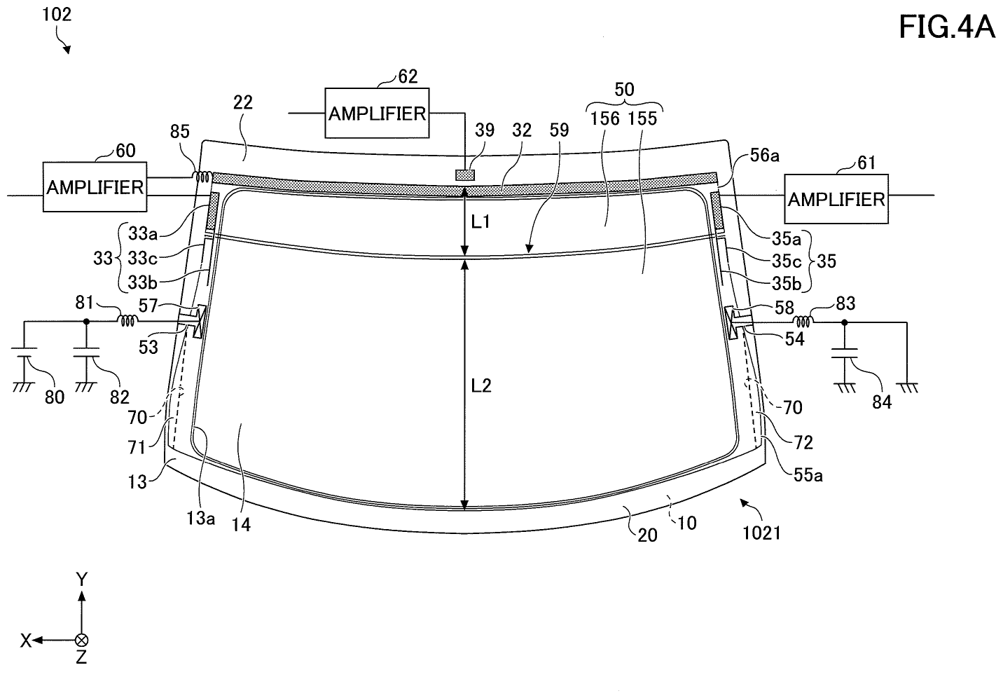

FIG. 3 is an exploded perspective view depicting an example of a configuration of a window glass for vehicle according to a second embodiment. FIG. 4 is a plan view depicting an example of a configuration of the window glass for vehicle according to the second embodiment. Explanations of the same configuration and the same effect as those in the second embodiment will be omitted.

The window glass 102 includes a glass plate 10 arranged on the vehicle outside, a glass plate 20 arranged on the vehicle inside, and a planar conductor 50 arranged inside a laminated glass.

The planar conductor 50 according to the second embodiment, illustrated in FIGS. 3 and 4, is separated into two parts by a dividing line 59 extending in the horizontal direction. In a state of being installed in a vehicle, the two pieces are referred to as an upper conductor region 156 above the dividing line 59 and a lower conductor region 155 below the dividing line 59. The upper conductor region 156 is an example of a first conductor region, and the lower conductor region 155 is an example of a second conductor region. For example, the upper conductor region 156 is provided with a conductive film 56, and the lower conductor region 155 is provided with a conductive film 55 and a pair of bus bars 51 and 52 connected to the conductive film 55.

A positive electrode 57 and a negative electrode 58 are not connected to the upper conductor region 156, but are connected to the lower conductor region 155. A direct current voltage is not applied to the upper conductor region 156, and the conductive film 56 does not generate heat. A direct current voltage is applied to the lower conductor region 155, and the conductive film 55 functions as a heater.

The feeding electrode 33 and the grounding electrode 37 face the planar conductor 50 via the glass plate 20 so that the planar conductor 50 receives at least electromagnetic waves of the VHF band. The feeding electrode 33 faces only the upper conductor region 156 via the glass plate 20, or faces the upper conductor region 156 and the lower conductor region 155 via the glass plate 20. The grounding electrode 37 does not face the upper conductor region 156 via the glass plate 20, but faces the lower conductor region 155 via the glass plate 20. The feeding electrode 33 and the grounding electrode 37 facing the planar conductor 50 via the glass plate 20, form an inverted F antenna to which a power is fed via a capacitive coupling. The feeding electrode 33 and the grounding electrode 37 face the planar conductor 50 via the glass plate 20 so as to form the inverted F antenna receiving at least electromagnetic waves of the VHF band. Thus, the window glass 102 has an antenna gain for the VHF band. The feeding electrode 33 may be formed so as to receive at least electromagnetic waves of the UHF band.

The window glass 102 may be further provided with a feeding electrode 35 and a grounding electrode 38 arranged on the vehicle inside surface of the laminated glass. Because the feeding electrode 35 and the grounding electrode 38 have been explained as above, in the following the feeding electrode 35 and the grounding electrode 38 will not be explained in detail.

The window glass 102 may be further provided with a feeding electrode 32 arranged on the vehicle inside surface of the laminated glass. The feeding electrode 32 faces the upper conductor region 156 via the glass plate 20, so that the upper conductor region 156 receives at least electromagnetic waves of the MF band. That is, the feeding electrode 32 faces the upper conductor region 156 via the glass plate 20 so that at least a part of the upper conductor region 156 functions as a radiation conductor that receives electromagnetic waves of the MF band. Because the feeding electrode 32 has been explained as above, in the following the feeding electrode 32 will not be explained in detail.

FIG. 4 is a plan view depicting an example of the configuration of the window glass for vehicle according to the second embodiment. A vertical size of the upper conductor region 156 is L1 and a vertical size of the lower conductor region 155 is L2. A ratio, L1/L2, preferably falls within a range of 1/15 to ⅓. When the ratio L1/L2 falls within the range of 1/15 to ⅓, the window glass has at least an antenna gain for the VHF band, a good appearance of the window glass, a sufficient field of vision of the window glass, and an antifogging effect. When the ratio L1/L2 is less than 1/15, the area of the upper conductor region 156 decreases and the antenna gain for the MF band becomes small. When the ratio L1/L2 exceeds ⅓, the area of the lower conductor region 155 decreases and a region having the antifogging function becomes small.

An inner edge 13a of the light shielding film 13 is located within an outer edge 56a of the upper conductor region 156 and an outer edge 55a of the lower conductor region 155 except for portions of the outer edges 56a and 55a along the dividing line 59. Thus, the outer edge 56a and the outer edge 55a, except for the portions along the dividing line 59, overlap with the light shielding film 13 in the planar view, and an outer edge of the planar conductor 50 is not viewed according to the light shielding film 13, and the appearance of the window glass is enhanced.

The choke coil 86, illustrated in FIG. 2, may be omitted in the window glass device 1020 according to the second embodiment (See FIG. 4). The upper conductor region 156 that receives electromagnetic waves of the MF band is separated from the lower conductor region 155, to which direct current electric voltage from the direct current power source 80 is applied, and a path through which signals obtained by receiving electromagnetic waves of the MF band such as AM broadcast waves leak to the ground level is blocked.

The window glass device 1020 may be provided with a coil 85 connected to the feeding electrode 32. The coil 85 is preferably an inductor coil that blocks at least signals obtained from receiving electromagnetic waves of the VHF band.

### Variation of the Second Embodiment

FIG. 4A is a diagram depicting an example of a configuration of a window glass device for vehicle according to a variation of the second embodiment. The window glass device for vehicle 1021 according to the variation of the second embodiment illustrated in FIG. 4A has a conductive film 55 arranged between a glass plate 10 arranged on the vehicle outside and a glass plate 20 arranged on the vehicle inside; and parts that face the metal body of the vehicle (flanges) on the right and the left of the conductive film 55, in the planar view. Dashed lines in FIG. 4A indicate boundaries (edge portions) of the vehicle metallic body. The conductive film 55 has right and left regions that face the parts of the vehicle made of metal, i.e. a first side region 71 and a second side region 72. In the window glass device for vehicle 1021, the first side region 71 or the second side region 72 may be absent.

The metallic body region illustrated in FIG. 4A facing the first side region 71, in the planar view, corresponds to the grounding electrode 37, and the metallic body region facing the second side region 72 corresponds to the grounding electrode 38. Thus, the grounding electrode in the window glass device 1021 according to the embodiment may be the metallic body of the vehicle. For a material between the first side region 71 and the metallic body and a material between the second side region 72 and the metallic body, the material described in the second variation of the first embodiment (including air) may be used. The material is connected to the ground level via a capacitive coupling.

To the window glass device for vehicle according to the second embodiment, the first variation of the first embodiment may be applied, as described above. Moreover, the window glass device for vehicle according to the second embodiment may be provided with the first side region 71 and the second side region 72 according to any one of the second to fifth variations of the first embodiment. Furthermore, the window glass device for vehicle according to the second embodiment may be provided with the first linear conductor 87 and the (non-illustrated) second linear conductor according to the sixth variation of the first embodiment. In any of the window glass devices for vehicle, to which the first to sixth variations of the first embodiment are applied, a metallic body is required to be used for the grounding electrode, and a part that is conductively connected to the conductive film 55 and the metallic body are required to be capacitively coupled with each other with a coupling capacitance or a combined coupling capacitance of 3 pF or more for signals with a predetermined frequency.

Areas of the first side region 71 and the second side region 72 are determined so as to obtain a stable connection to the metallic body (ground level), and preferably fall within the range described in the variations of the first embodiment. Moreover, in the window glass device for vehicle 1021, illustrated in FIG. 4A, the metallic body is used for the grounding electrode. The present invention is not limited to this, and the grounding electrodes 37 and 38 in the window glass device for vehicle 1020 illustrated in FIG. 4 may be used in addition to the metallic body.

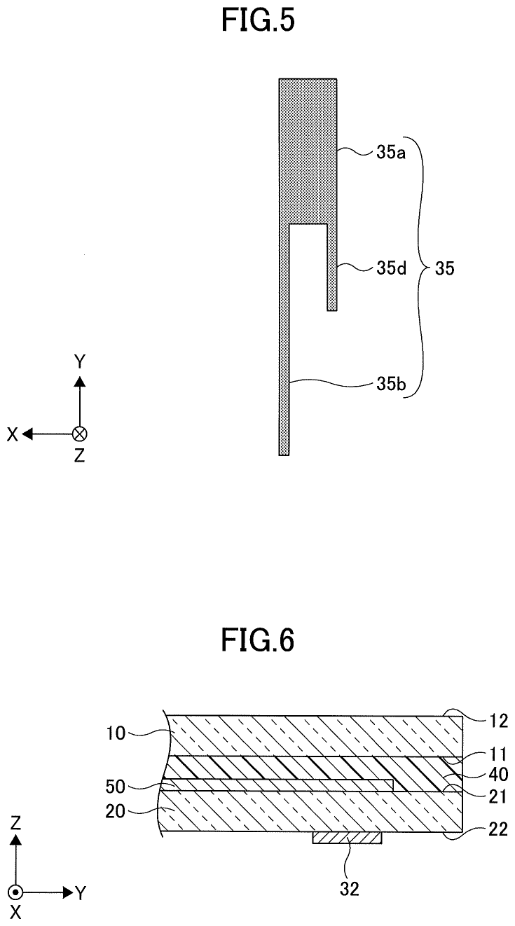

FIG. 5 is a diagram depicting another example of the configuration of the feeding electrode 35 according to the embodiment. The feeding electrode 35 has a rectangular element 35a, a linear element 35b and a linear element 35d. The feeding electrode 35 is formed so as to extend in the Y-axis direction. The linear element 35b is an example of the first element. The linear element 35d is an example of the second element.

The linear element 35d extends from a lower side of the rectangular element 35a, the linear element 35b being connected to the lower side. The linear element 35d includes a part extending in a direction parallel to a right side of the rectangular element 35a. The linear element 35d is shorter than the linear element 35b. Antenna gains of the terrestrial digital television broadcast waves or the UHF band such as L-Band of DAB are adjusted by changing the length of the linear element 35d.

In the feeding electrode 35, the linear element 35d may be absent, and the linear elements 35b and 35d may be absent. The feeding electrode 33 has the same configuration as the feeding electrode 35, and an explanation of the feeding electrode 33 will be omitted.

FIGS. 6 to 11 are diagrams depicting examples of lamination structures of the window glasses for vehicle according to variations of the embodiment. Although in each of FIGS. 6 to 11, the feeding electrode 32 arranged on the plate surface 22 is shown, other feeding electrodes and the grounding electrode are arranged in the same way as the feeding electrode 32.

In each of the lamination structures illustrated in FIGS. 6 to 8, the planar conductor 50 is arranged between the glass plate 10 and the glass plate 20. The planar conductor 50 and the feeding electrode 32 are arranged so as to overlap with each other via the glass plate 20, in the planar view in a thickness direction of the glass plate 20 (Z-axis direction). The planar conductor 50 contacts the intermediate film 40 arranged between the glass plate 10 and the glass plate 20.

FIG. 6 shows the planar conductor 50 formed on the plate surface 21 of the glass plate 20. For example, the planar conductor 50 is famed on a conductive film deposited on the plate surface 21 of the glass plate 20.

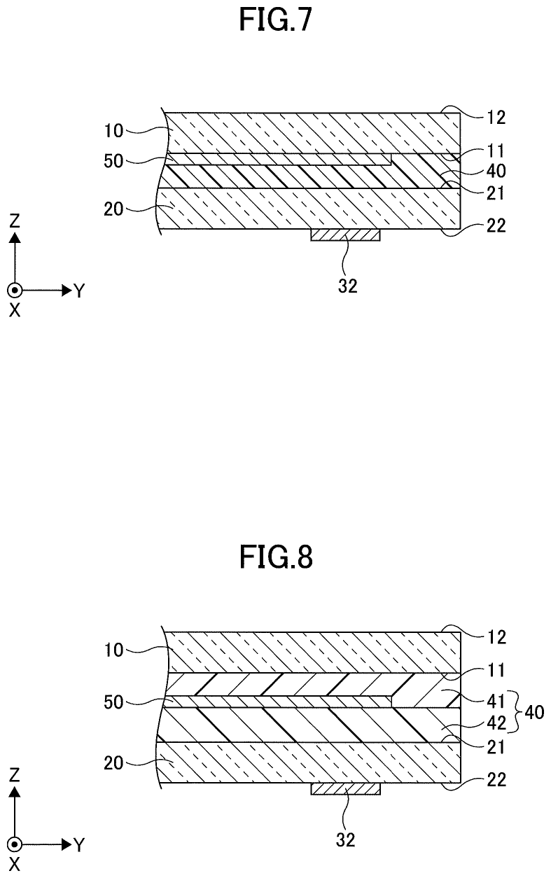

FIG. 7 shows the planar conductor 50 formed on the plate surface 11 of the glass plate 10. For example, the planar conductor 50 is famed on a conductive film deposited on the plate surface 11 of the glass plate 10. The intermediate film 40 may be present in addition to the glass plate 20 between the planar conductor 50 and the feeding electrode 32, as illustrated in FIG. 7.

FIG. 8 shows the planar conductor 50 arranged between the intermediate film 41 and the intermediate film 42. The intermediate film 41 is an example of a first layer included in the intermediate film 40, and the intermediate film 42 is an example of a second layer included in the intermediate film 40. For example, the planar conductor 50 is interposed between the intermediate film 41 that contacts the plate surface 11 of the glass plate 10 and the intermediate film 42 that contacts the plate surface 21 of the glass plate 20. In addition to the glass plate 20, the intermediate film 42 may be present between the planar conductor 50 and the feeding electrode 32, as illustrated in FIG. 8.

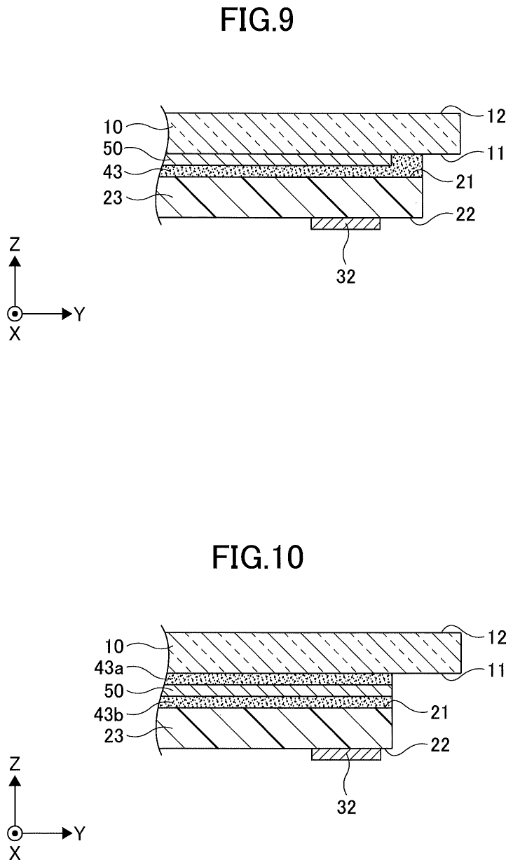

As shown in FIGS. 9 to 11, the window glass for vehicle according to the present disclosure is not limited to a laminated glass. A size of a dielectric arranged between the planar conductor 50 and the feeding electrode 32 may be different from the size of the glass plate 10. The dielectric may be a dielectric substrate or a dielectric film having a size that is sufficient for forming the feeding electrode 32.

The planar conductor 50, illustrated in each of FIGS. 9 to 11, is arranged between the glass plate 10 and the dielectric substrate 23. The planar conductor 50 and the feeding electrode 32 are arranged so as to overlap with each other via the dielectric substrate 23, in the planar view in the thickness direction of the dielectric substrate 23 (Z-axis direction). The dielectric substrate 23 is, for example, a printed board made of resin (e.g. a glass epoxy substrate in which a copper foil is attached to FR4 (Flame Retardant Type 4)), or may be replaced with a dielectric film.

FIG. 9 shows the planar conductor 50 formed on the plate surface 11 of the glass plate 10.

For example, the planar conductor 50 is formed on a conductive film deposited on the plate surface 11 of the glass plate 10. The feeding electrode 32 is arranged on the plate surface 22 of the dielectric substrate 23. The dielectric substrate 23 is bonded to the planar conductor 50 via an adhesion layer 43 so that the feeding electrode 32 faces the planar conductor 50.

FIG. 10 shows the planar conductor 50 formed over the plate surface 11 of the glass plate 10. For example, the planar conductor 50 is bonded to the plate surface 11 via an adhesion layer 43a. The feeding electrode 32 is arranged on the plate surface 22 of the dielectric substrate 23. The dielectric substrate 23 is bonded to the planar conductor 50 via an adhesion layer 43b so that the feeding electrode 32 faces the planar conductor 50.

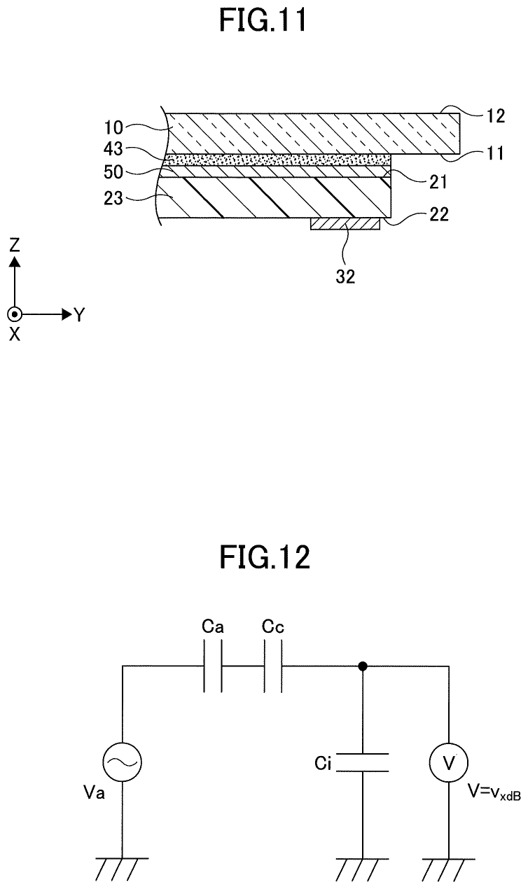

FIG. 11 shows the dielectric substrate 23 bonded to the plate surface 11 of the glass plate 10 via the adhesion layer 43. For example, the dielectric substrate 23 includes the plate surface 21 on which the planar conductor 50 is formed; and the plate surface 22 on which the feeding electrode 32 is formed so that at least a part of a dielectric of the dielectric substrate 23 is interposed between the planar conductor 50 and the feeding electrode 32. The planar conductor 50 may be embedded in the dielectric substrate 23.

In the window glass for vehicle according to the embodiment, at least a part of the planar conductor 50 faces the feeding electrode 32 via a dielectric (a glass plate, a dielectric substrate, or the like). Thus, signals obtained by receiving at the planar conductor 50 are extracted from the feeding electrode 32 via a capacitive coupling between the planar conductor 50 and the feeding electrode 32. Signals extracted from the feeding electrode 32 are transferred to the input unit of the amplifier 60 (See FIG. 1 and the like) via a feeding line (conductive member) that is conductively connected to the feeding electrode 32. The conductive member specifically includes an AV line, a coaxial cable, and the like.

When a coaxial cable is used for the feeding line, a core wire (inner conductor) is connected to the feeding electrode 32, and an outer conductor of the coaxial cable is connected to the ground level such as a vehicle body. Moreover, a connector for connecting the amplifier 60 to the feeding electrode 32 may be used. The feeding electrode 32 is provided with the connector, for example. Alternatively, the connector may be provided with the amplifier 60. A coaxial cable may be applied to the feeding electrode 33, 35 or 39. The connector may similarly be provided with the amplifier 61 or the amplifier 62.

Signals obtained by receiving at the planar conductor 50 are extracted from the feeding electrode 32 via the capacitive coupling between the planar conductor 50 and the feeding electrode 32. The input unit of the amplifier 60 is directly or indirectly connected to the feeding electrode 32. The amplifier 60 amplifies the signals extracted from the feeding electrode 32, and outputs the amplified signals to the signal processing circuit (not shown) installed in the vehicle.

An equivalent circuit for the process from the planar conductor 50 to the amplifier 60 of the MF band is expressed by a circuit shown in FIG. 12.

For the first embodiment illustrated in FIGS. 1 and 2, C_{c} in FIG. 12 is the coupling capacitance between the planar conductor 50 and the feeding electrode 32, Cₐ is an antenna capacitance of the planar conductor 50, and Cᵢ is an input capacitance of the amplifier 60 connected to the feeding electrode 32. Moreover, v_{xdB} is a voltage value, which is lower by x decibels than a voltage value V output from the feeding electrode 32 when the coupling capacitance C_{c} is infinity, and vₐ is a reception voltage value of the planar conductor 50. When the coupling capacitance C_{c} satisfies the following relation (1), a coupling loss in the capacitive coupling between the planar conductor 50 and the feeding electrode 32 is x decibels or less. The value of x is 3.0 or less. Moreover, the value of x is preferably 2.0 or less, more preferably 1.0 or less, and further preferably 0.5 or less.

$$\begin{matrix}[ Math 1 ] & \\ {C}_{c} \geq \frac{{C}_{i} \times {C}_{a} \times \frac{{V}_{xdB}}{{V}_{a}}}{{C}_{a} - ( {C}_{a} + {C}_{i} ) \times \frac{{V}_{xdB}}{{V}_{a}}} & ( formula 1 )\end{matrix}$$

For the first embodiment illustrated in FIGS. 1 and 2, Cₐ is a capacitance between the planar conductor 50 and the ground level of the vehicle body or the like. Cᵢ is an input capacitance between the input unit of the amplifier 60 and the ground level of the vehicle body or the like. “When the coupling capacitance C_{c} is infinity” means that the planar conductor 50 and the feeding electrode 32 are directly connected to each other via a conductor without the capacitive coupling. That is, it represents a state where the coupling loss in the coupling capacitance between the planar conductor 50 and the feeding electrode 32 is zero.

For the second embodiment illustrated in FIGS. 3 and 4, C_{c} in FIG. 12 is a coupling capacitance between the upper conductor region 156 and the feeding electrode 32, Cₐ is an antenna capacitance of the upper conductor region 156, and Cᵢ is an input capacitance of the amplifier 60 connected to the feeding electrode 32. Moreover, v_{XdB} is a voltage value, which is lower by x decibels than a voltage value V output from the feeding electrode 32 when the coupling capacitance C_{c} is infinity, and vₐ is a reception voltage value of the upper conductor region 156. When the coupling capacitance C_{c} satisfies the following relation (1), a coupling loss in the capacitive coupling between the upper conductor region 156 and the feeding electrode 32 is x decibels or less.

For the second embodiment illustrated in FIGS. 3 and 4, Cₐ is a capacitance between the upper conductor region 156 and the ground level of the vehicle body or the like. Cᵢ is an input capacitance between the input unit of the amplifier 60 and the ground level of the vehicle body or the like. “When the coupling capacitance C_{c} is infinity” means that the upper conductor region 156 and the feeding electrode 32 are directly connected to each other via a conductor without the capacitive coupling. That is, it represents a state where the coupling loss in the coupling capacitance between the upper conductor region 156 and the feeding electrode 32 is zero.

In each embodiment, the state where the coupling capacitance C_{c} is infinity is an ideal state in which a coupling loss is absent in the capacitive coupling. Because the coupling loss in the coupling capacitance is smaller in accordance with the coupling capacitance C_{c} being larger, a divided voltage applied to the input capacitance Cᵢ (voltage input to the amplifier 60) can be prevented from decreasing due to the coupling loss. Thus, when the coupling capacitance C_{c} is set so as to satisfy the relation (1), a voltage input to the amplifier 60 can be prevented from decreasing due to the coupling loss. Thus, in the case of extracting, via a capacitive coupling, signals obtained by receiving electromagnetic waves in the frequency band of the AM broadcasting, an electric voltage input to the amplifier 60 is secured, and a sufficient receiving sensitivity is obtained in the amplifier 60.

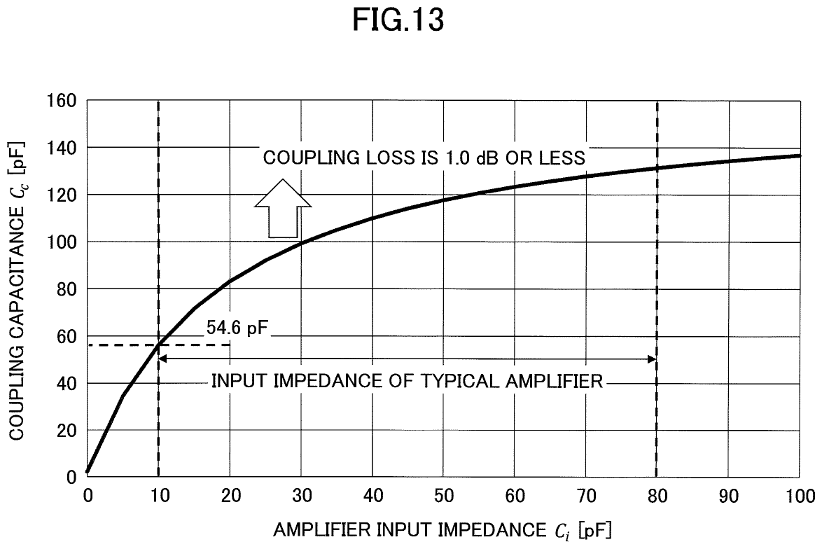

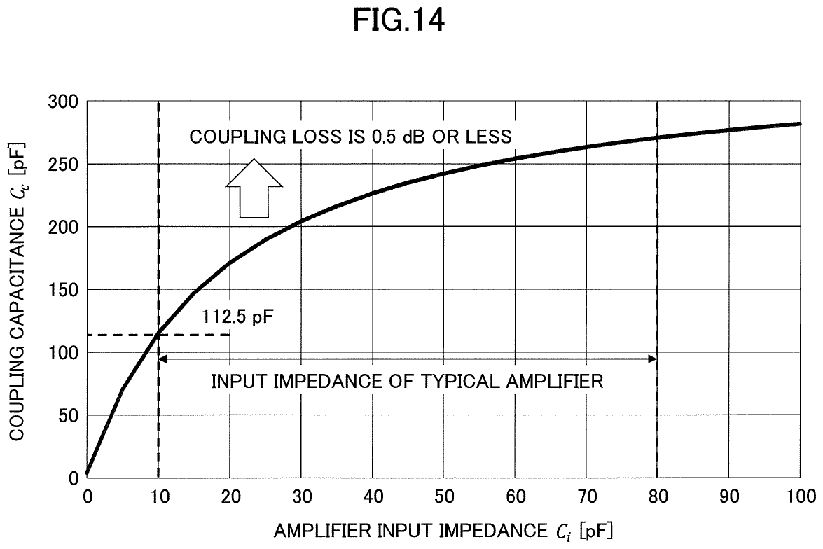

FIG. 13 is a diagram showing an example of a result of a simulation measuring a relation between an input capacitance Cᵢ of the amplifier 60 and the coupling capacitance C_{c}, where the coupling loss is 1.0 dB. FIG. 14 is a diagram showing an example of a result of simulation measuring a relation between an input capacitance Cᵢ of the amplifier 60 and the coupling capacitance C_{C}, where the coupling loss is 0.5 dB.

Curves shown in FIGS. 13 and 14 are expressed by the following relation (2). The value of x is 3.0 or less. The value of x is preferably 2.0 or less, more preferably 1.0 or less, and further preferably 0.5 or less.

$$\begin{matrix}[ Math 2 ] & \\ {C}_{c} = \frac{{C}_{i} \times {C}_{a} \times \frac{{V}_{xdB}}{{V}_{a}}}{{C}_{a} - ( {C}_{a} + {C}_{i} ) \times \frac{{V}_{xdB}}{{V}_{a}}} & ( formula 2 )\end{matrix}$$

A curve shown in FIG. 13 indicates the case where x is 1.0 for v_{XdB} in the above-described relation (2), and a curve shown in FIG. 14 indicates the case where x is 0.5 for v_{XdB}. Because typically an antenna capacitance of an antenna element for receiving AM broadcast waves falls within a range of 20 pF to 80 pF, the antenna capacitance Cₐ in FIGS. 13 and 14 is set to the minimum value of the range (i.e. 20 pF). Moreover, typically an input capacitance of an amplifier falls within a range of 10 pF to 80 pF.

Thus, as illustrated in FIG. 13, for example, in the case of using an amplifier 60 with an input capacitance Cᵢ of 10 pF, by designing the antenna so that the coupling capacitance C_{c} is 54.6 pF or more, the coupling loss can be made 1.0 dB or less, and the receiving sensitivity of the amplifier 60 can be enhanced. Moreover, as illustrated in FIG. 14, for example, in the case of using an amplifier 60 with an input capacitance Cᵢ of 10 pF, by designing the antenna so that the coupling capacitance C_{c} is 112.5 pF or more, the coupling loss can be made 0.5 dB or less, and the receiving sensitivity of the amplifier 60 can be enhanced.

In a planar view in the thickness direction of the dielectric, the coupling capacitance C_{c} is larger in accordance with an area where the planar conductor 50 and the feeding electrode 32 overlap with each other (in the following, also referred to as an “overlapping area A”) being larger. Thus, the overlapping area A is preferably larger in reducing the coupling loss. However, when an upper limit of the overlapping area A is calculated taking into account an upper limit of an area of the glass plate or the dielectric substrate, an upper limit of the coupling capacitance C_{c} is about 3500 pF.

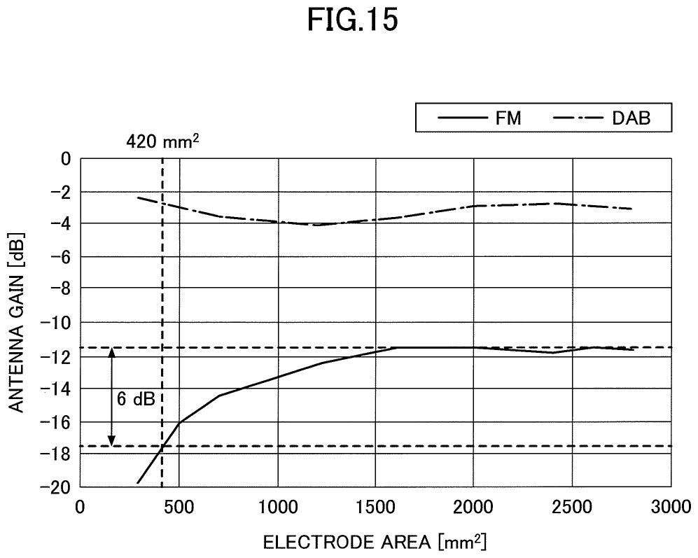

FIG. 15 is a diagram depicting an example of a relation between the area A_{F} and the antenna gain of the feeding electrode 33 or the feeding electrode 35. When the area A_{F} varies, the antenna gain of the frequency band of FM broadcast waves changes more significantly than the antenna gain of the frequency band of Band III of DAB. Thus, the area A_{F} is preferably 420 mm² or more in enhancing the antenna gain of the frequency band of FM broadcast waves, as shown in FIG. 15. When the area A_{F} is less than 420 mm², the antenna gain is lower by about 6 dB (decibels) than the maximum value of the antenna gain.

TABLE 1 shows an example of a result of test for the antenna gain of the window glass for vehicle according to the second embodiment illustrated in FIGS. 3 and 4 (i.e. the window glass 102 with divided coatings (conductive films)). TABLE 2 shows an example of a result of test for the antenna gain of the window glass for vehicle according to the first embodiment illustrated in FIGS. 1 and 2 (i.e. the window glass 101 with undivided coating (conductive film)).

In the test for the antenna gain of the window glass for vehicle, the feeding electrode 33 (35) includes a rectangular element 33a (35a) with a dimension of 10 mm×110 mm having a long side in the Y-axis direction. The feeding electrode 33 (35) includes a linear element 33b (35b) with a width of 0.8 mm extending by 110 mm in the Y-axis direction from a lower side of the rectangular element 33a (35a). The feeding electrode 33 (35) further includes an L-shaped bent element 33c (35c) with a width of 0.8 mm extending from a branching point on the linear element 33b (35b) separated from the lower side of the rectangular element 33a (35a) by 10 mm. The bent element 33c (35c) extends by 10 mm in the X-axis direction from the branching point and then extends by 50 mm in the Y-axis direction. Moreover, the feeding electrode 39 includes a rectangular element 39a with a dimension of 20 mm×10 mm, and linear elements extending by 40 mm in the X-axis positive direction and in the X-axis negative direction. The feeding electrode 32 includes a rectangular element with a dimension of 10 mm×1020 mm in the upper edge part of the window glass for vehicle.

The planar conductor 50 of the window glass for vehicle according to the second embodiment is divided into two by the dividing line 59 extending in the horizontal direction, in the state where the window glass for vehicle is installed in the vehicle. The vertical size L1 of the upper conductor region 156 is about 130 mm, and the vertical size L2 of the lower conductor region 155 is about 520 mm. A ratio of the sizes, L1/L2, is 0.25.

TABLE 1
divided coatings

| | |
|---|---|
| horizontal | vertical |
| polarization | polarization |

ECE FM/DAB/DTV Gain

| | | |
|---|---|---|
| FM1 | −6.4 | −2.5 |
| FM2 | −7.4 | −3.8 |
| DAB1 | −4.3 | −1.8 |
| DAB2 | −3.8 | −1.5 |
| DTV1 (Band4&5) | −7.0 | −4.2 |
| DTV2 (Band4&5) | −6.8 | −3.9 |
| DTV3 (Band4&5) | −5.8 | −3.3 |

JPN FM Gain

| | | |
|---|---|---|
| FM1 | −7.3 | −3.3 |
| FM2 | −8.6 | −4.8 |

unit: dB

TABLE 2
undivided coating

| | |
|---|---|
| horizontal | vertical |
| polarization | polarization |

ECE FM/DAB/DTV Gain

| | | |
|---|---|---|
| FM1 | −7.7 | −4.0 |
| FM2 | −6.8 | −2.4 |
| DAB1 | −4.7 | −1.8 |
| DAB2 | −3.6 | −0.6 |
| DTV1 (Band4&5) | −6.5 | −4.2 |
| DTV2 (Band4&5) | −6.9 | −4.9 |
| DTV3 (Band4&5) | −6.6 | −4.2 |

JPN FM Gain

| | | |
|---|---|---|
| FM1 | −6.8 | −3.5 |
| FM2 | −6.7 | −3.5 |

unit: dB

TABLES 1 and 2 show measured antenna gains (average values) for the frequency bands used in Europe (ECE) and Japan (JPN). The frequency bands used in ECE include FM (87 to 108 MHz), DAB (170 to 240 MHz) and DTV Band 4&5 (470 to 790 MHz). The frequency bands used in Japan include FM (76 to 108 MHz). FM1 indicates signals output from the feeding electrode 33 receiving FM broadcast waves of the FM band, and FM2 indicates signals output from the feeding electrode 35 receiving FM broadcast waves of the FM band. DAB1 indicates signals output from the feeding electrode 33 receiving electromagnetic waves of the DAB band, and DAB2 indicates signals output from the feeding electrode 35 receiving electromagnetic waves of the DAB band. DTV1 indicates signals output from the feeding electrode 33 receiving electromagnetic waves of the DTV band, DTV2 indicates signals output from the feeding electrode 35 receiving electromagnetic waves of the DTV band, and DTV3 indicates signals output from the feeding electrode 39 receiving electromagnetic waves of the DTV band. The values of the antenna gain shown in TABLES 1 and 2 satisfy the requirement for the reception sensitivities of the frequency bands.

TABLE 3 shows an example of a result of test for the antenna gain of the window glass for vehicle according to the first and second embodiments.

TABLE 3

| | divided coatings | undivided coating |
|---|---|---|
| AM | 19.4 | 22.9 |

unit: dBμV

TABLE 3 shows antenna gains obtained by measuring signals output from the feeding electrode 32, averaging values at a plurality of frequencies (594 kHz, 693 kHz, 810 kHz, 954 kHz, 1134 kHz, 1242 kHz and 1422 kHz), which are included in the frequency band used for AM broadcast waves (531 to 1720 kHz). The values of the antenna gain shown in TABLE 3 satisfy the requirement for the reception sensitivity of the AM frequency band.

As described above, the preferred embodiments and the like of the window glass for vehicle have been described. However, the present invention is not limited to the above-described specific embodiments. Various variations and modifications, such as combinations with a part or a whole of the other embodiment or replacement, may be made within the scope of the present invention.

### REFERENCE SIGNS LIST

10 glass plate (example of first glass plate)
13 light-shielding film
14 transmissive region
20 glass plate (example of second glass plate or dielectric)
21 plate surface (example of first plate surface)
22 plate surface (example of second plate surface)
23 dielectric substrate (example of dielectric)
32 feeding electrode (example of second feeding electrode)
33, 35 feeding electrode
37, 38 grounding electrode
39 feeding electrode (example of conductive pattern)
40 intermediate film
41 first layer
42 second layer
43 adhesion layer
50 planar conductor
50b notch part
51, 52 bus bar
55, 56 conductive film
57 positive electrode
58 negative electrode
59 dividing line
60, 61, 62 amplifier
63 casing
70 dashed line (boundary (edge portion) of metallic body)
71 first side region
72 second side region
73, 77, 89 first connection part
75 first capacitive coupling part
86 choke coil
87 first linear conductor
101, 102 window glass
155 lower conductor region (example of second conductor region)
156 upper conductor region (example of first conductor region)
1010, 1010a, 1011, 1012, 1013, 1014, 1015, 1020, 1021 window glass device (example of window glass device for vehicle)

What is claimed is:

1. A window glass for vehicle comprising:
a glass plate having a transmissive region that transmits visible light, and a light shielding film that shields visible light arranged around the transmissive region;
a dielectric having a first surface that faces the glass plate, and a second surface opposite to the first surface;
a planar conductor arranged between the glass plate and the first surface of the dielectric;
a positive electrode connected to the planar conductor;
a negative electrode connected to the planar conductor;
one or more feeding electrodes arranged on the second surface of the dielectric; and
one or more grounding electrodes arranged on the second surface of the dielectric,
wherein the planar conductor generates heat by an electric voltage applied between the positive electrode and the negative electrode,
wherein the feeding electrodes and the grounding electrodes are arranged to face the planar conductor via the dielectric so that the planar conductor receives at least electromagnetic waves of a VHF band, and
wherein the positive electrode, the negative electrode, the feeding electrodes and the grounding electrodes are arranged to overlap with the light shielding film in a planar view.

2. The window glass for vehicle according to claim 1,
wherein an area of a feeding electrode from among the one or more feeding electrodes is 420 mm² or more and 8000 mm² or less.

3. The window glass for vehicle according to claim 1,
wherein a feeding electrode from among the one or more feeding electrodes includes a rectangular element formed in a rectangular shape.

4. The window glass for vehicle according to claim 3,
wherein the feeding electrode further includes a first element that extends from a side of the rectangular element, the first element having a width that is smaller than a length of one side of the rectangular element.

5. The window glass for vehicle according to claim 4,
wherein the rectangular element is an oblong element having an oblong shape, and
wherein the first element has a width that is smaller than a length of a short side of the oblong element.

6. The window glass for vehicle according to claim 5,
wherein the feeding electrode further includes a second element conductively connected to the oblong element, and
wherein the second element has a width that is smaller than the length of the short side of the oblong element.

7. The window glass for vehicle according to claim 6,
wherein the second element extends from a part of the first element other than an end portion of the first element, in a direction orthogonal to the extending direction of the first element, bends, further extends, and has an open end.

8. The window glass for vehicle according to claim 1,
wherein the feeding electrode and the grounding electrode are arranged along one side of the transmissive region.

9. The window glass for vehicle according to claim 1,
wherein a feeding electrode and a grounding electrode are arranged outward with respect to a first side of the transmissive region, and another feeding electrode and another grounding electrode are arranged outward with respect to a second side of the transmissive region, the feeding electrode and the another feeding electrode being from among the one or more feeding electrodes and the grounding electrode and the another grounding electrode being from among the one or more grounding electrodes.

10. The window glass for vehicle according to claim 1,
wherein the planar conductor is famed by a conductor surface.

11. The window glass for vehicle according to claim 10 further comprising:
a second feeding electrode arranged on the second surface of the dielectric, the one or more feeding electrodes being second feeding electrodes,
wherein the second feeding electrode faces the planar conductor via the dielectric so that the planar conductor receives at least electromagnetic waves of the MF (Medium Frequency) band.

12. The window glass for vehicle according to claim 11,
wherein a coupling capacitance C_{c} between the planar conductor and the second feeding electrode satisfies a relation
$${C}_{c} \geq \frac{{C}_{i} \times {C}_{a} \times \frac{{V}_{xdB}}{{V}_{a}}}{{C}_{a} - ( {C}_{a} + {C}_{i} ) \times \frac{{V}_{xdB}}{{V}_{a}}}$$
where Cₐ is an antenna capacitance of the planar conductor, Cᵢ is an input capacitance of an amplifier connected to the second feeding electrode, v_{xdB} is a voltage value, which is lower by x decibels than a voltage value output from the second feeding electrode when the coupling capacitance C_{c} is infinity, and vₐ is a reception voltage value of the planar conductor.

13. The window glass for vehicle according to claim 1,
wherein the planar conductor is divided by a dividing line extending in a horizontal direction, and includes, in a state where the window glass for vehicle is installed in a vehicle, a first conductor region above the dividing line and a second conductor region below the dividing line,
wherein the positive electrode and the negative electrode are not connected to the first conductor region, and the positive electrode and the negative electrode are connected to the second conductor region,
wherein the one or more feeding electrodes face the first conductor region via the dielectric, or face both the first conductor region and the second conductor region via the dielectric,
wherein the one or more grounding electrodes do not face the first conductor region, and face the second conductor region via the dielectric, and
wherein when a vertical size of the first conductor is denoted as L1, and a vertical size of the second conductor is denoted as L2, a ratio, L1/L2 is 1/15 or more and ⅓ or less.

14. The window glass for vehicle according to claim 13 further comprising:
a second feeding electrode arranged on the second surface of the dielectric, the one or more feeding electrodes being second feeding electrodes,
wherein the second feeding electrode faces the first conductor region via the dielectric so that the first conductor region receives at least electromagnetic waves of the MF (Medium Frequency) band.

15. The window glass for vehicle according to claim 14,
wherein a coupling capacitance C_{c} between the first conductor region and the second feeding electrode satisfies a relation
$${C}_{c} \geq \frac{{C}_{i} \times {C}_{a} \times \frac{{V}_{xdB}}{{V}_{a}}}{{C}_{a} - ( {C}_{a} + {C}_{i} ) \times \frac{{V}_{xdB}}{{V}_{a}}}$$
where Cₐ is an antenna capacitance of the first conductor region, Cᵢ is an input capacitance of an amplifier connected to the second feeding electrode, v_{xdB}, is a voltage value, which is lower by x decibels than a voltage value output from the second feeding electrode when the coupling capacitance C_{c} is infinity, and vₐ is a reception voltage value of the first conductor region,
wherein x is 3.0 or less.

16. A window glass device for vehicle comprising:
the window glass for vehicle according to claim 11; and
a choke coil connected to the positive electrode and the negative electrode,
wherein the choke coil blocks at least signals of the MF band.

17. A window glass device for vehicle comprising:
the window glass for vehicle according to claim 1;
a positive electrode side coil connected to the positive electrode; and
a negative electrode side coil connected to the negative electrode,
wherein the positive electrode side coil and the negative electrode side coil block at least signals of a VHF band.

18. A window glass device for vehicle comprising:
the window glass for vehicle according to claim 1,
wherein the planar conductor has a side region facing a metallic body of a vehicle on at least one of right and left sides of the planar conductor, and
wherein the grounding electrode is the metallic body.

19. A window glass device for vehicle comprising:
the window glass for vehicle according to claim 1,
wherein the planar conductor has a side region facing a metallic body of a vehicle on at least one of right and left sides of the planar conductor,
wherein the side region is connected to the planar conductor via a connection part that crosses a boundary of the metallic body in a planar view,
wherein the connection part includes a turnaround part that turns back along the second surface of the dielectric, the second surface facing the metallic body,
wherein the grounding electrode includes the metallic body, and
wherein a coupling capacitance C_{B} between the side region and the metallic body is 3 pF or more.

20. A window glass device for vehicle comprising:
the window glass for vehicle according to claim 1,
wherein the planar conductor is provided with a side region facing a metallic body of a vehicle on at least one of right and left sides of the planar conductor,
wherein the side region is electrically connected to a capacitive coupling part via a connection part,
wherein the capacitive coupling part is capacitively coupled with the planar conductor,
wherein the grounding electrode includes the metallic body, and
wherein a combined coupling capacitance C₂ of a coupling capacitance C_{B} between the side region and the metallic body and a coupling capacitance C₁ between the capacitive coupling part and the planar conductor, obtained by C₁·C_{B}/(C₁+C_{B}), is 3 pF or more.
